(19) United States
(12) Patent Application Publication
(10) Pub. No.: US 2016/0165312 A1
(43) Pub. Date: Jun. 9, 2016

(54) ELECTRONIC DEVICE, AND METHOD AND STORAGE MEDIUM

(71) Applicant: Kabushiki Kaisha Toshiba, Tokyo (JP)

(72) Inventors: Kenji Ochiai, Koganei-shi (JP); Kenji Yamazato, Ome-shi (JP); Hiroshi Ueda, Akishima-shi (JP); Tomoyuki Shirai, Iruma-shi (JP); Hirofumi Kanai, Fukaya-shi (JP); Tomohide Kawano, Tokyo (JP)

(21) Appl. No.: 15/040,894

(22) Filed: Feb. 10, 2016

Related U.S. Application Data
(62) Division of application No. 14/286,902, filed on May 23, 2014.

(30) Foreign Application Priority Data
May 27, 2013 (JP) 2013-111282

(51) Int. Cl. H04N 21/478; H04N 21/488; H04N 21/422

(52) U.S. Cl. CPC H04N 21/47815; H04N 21/42214; H04N 21/42203; H04N 21/4882

(57) ABSTRACT

According to one embodiment, an electronic device includes a receiver, a transmitter, a management module, and an informing module. The receiver receives a purchase instruction from a user. The transmitter transmits the received purchase instruction to a server via a network. The management module manages a purchase history of the user. The informing module determines, upon receiving the purchase instruction from the user, whether the received purchase instruction satisfies a predetermined condition based on a purchase history of a predetermined period, and sends a message to the user if the purchase instruction satisfies the predetermined condition.

### CROSS-REFERENCE TO RELATED APPLICATIONS

This application is a divisional application of U.S. patent application Ser. No. 14/286,902, filed May 23, 2014 and claims the benefit of priority from Japanese Patent Application No. 2013-111282, filed May 27, 2013, the entire contents of each of which are incorporated herein by reference.

### FIELD

Embodiments described herein relate generally to an electronic device that enables shopping utilizing a network, and a method and a storage medium.

### BACKGROUND

Net shopping (online shopping) in which shopping is performed utilizing a network, such as the Internet, has recently come into practical use. For instance, a system has been developed, wherein a supermarket opens a net supermarket on the Internet, a user places an order on a screen, and an ordered article is sent to the user after settlement.

In such an imaginary net shopping, various human errors may be raised because users do not actually pick up articles. Thus, there is a problem in convenience of shopping.

Conventional net shopping has a problem that various human errors may be raised because of virtual shopping.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates an example of the configuration of an Internet (online) shopping system according to an embodiment.

FIG. 2 is a block diagram showing an example of the configuration of the electronic device shown in FIG. 1.

FIG. 3 is a plan view of an example of the wireless keyboard shown in FIG. 1.

FIG. 4 is an exemplary outline flowchart of an example of Internet (online) shopping.

FIG. 5 illustrates an example of a power-on password input screen.

FIGS. 6A and 6B illustrate an example of store entrance screens.

FIG. 7 illustrates an example of a screen sequence leading a user into the store.

FIGS. 8A and 8B illustrate examples of purchase selection screens.

FIG. 9 is a flowchart of an example of the process performed after “1: Selection of sales section” is selected on the purchase selection screen of FIG. 8.

FIGS. 10A and 10B illustrate examples of sales section selection screens.

FIGS. 11A and 11B illustrate examples of article category selection screens.

FIG. 12 illustrates an example of an article selection screen.

FIG. 13 illustrates an example of a one-day duplicate-purchase warning screen.

FIG. 14 illustrates an example of a multi-day duplicate-purchase warning screen.

FIG. 15 illustrates an example of an article detailed information confirming screen.

FIG. 16 illustrates an example of an article confirmation/quantity designation screen.

FIG. 17 illustrates an example of an overmuch purchase warning screen.

FIG. 18 is a flowchart of an example of the process performed when a “shopping cart” key on the keyboard of FIG. 3 has been pressed.

FIG. 19 illustrates an example of a settlement screen.

FIG. 20 illustrates an example of an instant overbudget warning screen.

FIG. 21 illustrates an example of a regular purchase forgetting warning screen.

FIG. 22 illustrates an example of a finish/exit screen.

FIG. 23 is a flowchart of an example of the process performed after “2: Looking around store” is selected on the purchase selection screen of FIG. 8.

FIG. 24 illustrates an example of a screen sequence leading a user in the store.

FIGS. 25A and 25B illustrate an example of a first sales section (e.g., a meat section) screen, and an example of a store exit screen.

FIG. 26 illustrates an example of a second sales section (e.g., a vegetable section) screen.

FIG. 27 is a flowchart of an example of the process performed after “3: Voice search” is selected on the purchase selection screen of FIG. 8.

FIG. 28 illustrates an example of a voice input screen.

FIG. 29 illustrates an example of a confirmation alert screen.

FIG. 30 illustrates an example of a confirmation alert screen.

FIGS. 31A and 31B illustrate examples of category selection screens.

FIG. 32 illustrates an example of an article selection screen.

FIG. 33 is a flowchart of an example of the process performed after “4: Bargain/recommendation” is selected on the purchase selection screen of FIG. 8.

FIG. 34 illustrates an example of a “Bargain and recommendation” screen.

FIG. 35 is a flowchart of an example of the process performed after “5: Regular purchase” is selected on the purchase selection screen of FIG. 8.

FIGS. 36A and 36B illustrate examples of “Regular purchase” screens.

FIGS. 37A and 37B illustrate examples of customer information created in subscribing.

### DETAILED DESCRIPTION

Various embodiments will be described hereinafter with reference to the accompanying drawings.

In general, according to one embodiment, an electronic device includes a receiver, a transmitter, a management module, and an informing module. The receiver receives a purchase instruction from a user. The transmitter transmits the received purchase instruction to a server via a network. The management module manages a purchase history of the user. The informing module determines, upon receiving the purchase instruction from the user, whether the received purchase instruction satisfies a predetermined condition based on a purchase history of a predetermined period, and sends a message to the user if the purchase instruction satisfies the predetermined condition.

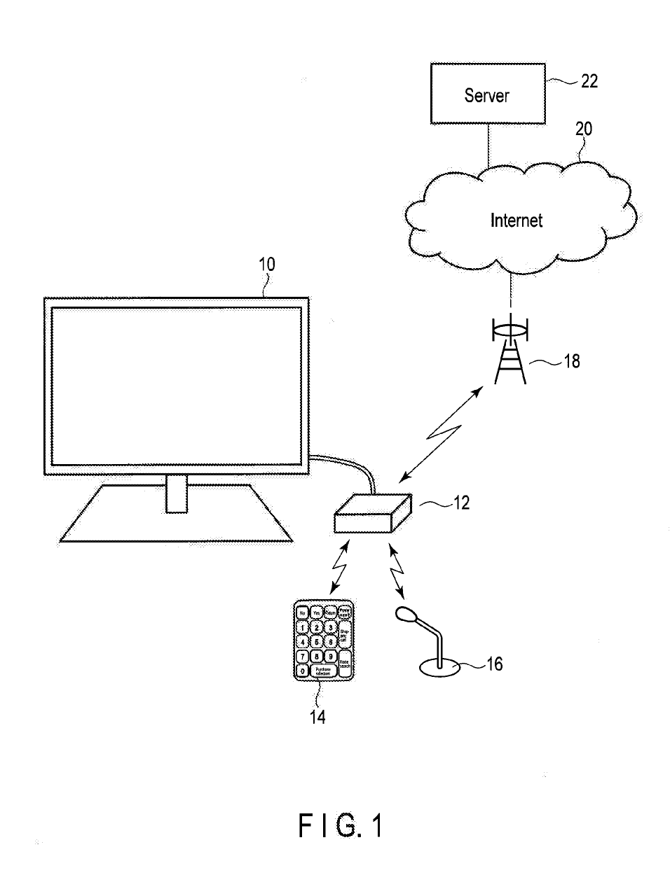

An embodiment will be described with reference to the accompanying drawings. FIG. 1 shows an example of a configuration of an Internet shopping system according to the embodiment. In this system, a general digital television receiver 10 is used instead of a dedicated terminal, and an electronic device 12 for realizing an Internet shopping (also referred to as “net shopping”) is connected to the digital television receiver 10. As the electronic device 12, an HDMI dongle to be connected to the digital television receiver 10 via an HDMI (trademark) cable is used, for example. The electronic device 12 is connected to a wireless keyboard 14 and a wireless microphone 16. Although the wireless microphone 16 is prepared for article search utilizing voice, described later, it is not necessary when article search is performed only by key input through the wireless keyboard 14. Even when the microphone is needed, the wireless keyboard 14 and the wireless microphone 16 may be formed integral as one body. Wireless connection is realized by, for example, Bluetooth (trademark) connection. The electronic device 12 is connected to a base station 18 and the Internet 20 via a 3G wireless line. However, the embodiment is not limited to this, but may be modified such that the connection is realized through a Wi-Fi (trademark) router. Further, the net shopping operator may be a mobile virtual network operator. The electronic device 12 has a function that enables the device to be connected to the Internet without any complex settings. The Internet 20 is also connected to a server 22 incorporated in a store that provides net shopping services. The server 22 enables net shopping, settlement, etc.

As described above, net shopping services can be provided simply by connecting the electronic device 12 to the existing television receiver 10. In general, aged persons, for example, may be unfamiliar with operations of personal computers, and be therefore reluctant to operate such a dedicated terminal as a personal computer. However, in the embodiment, the television receiver 10, with which they may be familiar, can be used as a net shopping terminal. Therefore, they may not have uncomfortable feeling in net shopping. Furthermore, since the television receiver 10 currently has a big screen and high quality sound, they can enjoy the video and audio data of the electronic device 12 with the big screen and high quality sound of the television receiver 10. In addition, the wireless keyboard 14 can be operated in the same way as the remote controller of the television receiver 10. Thus, they may not greatly be interrupted by the operation of the wireless keyboard 14.

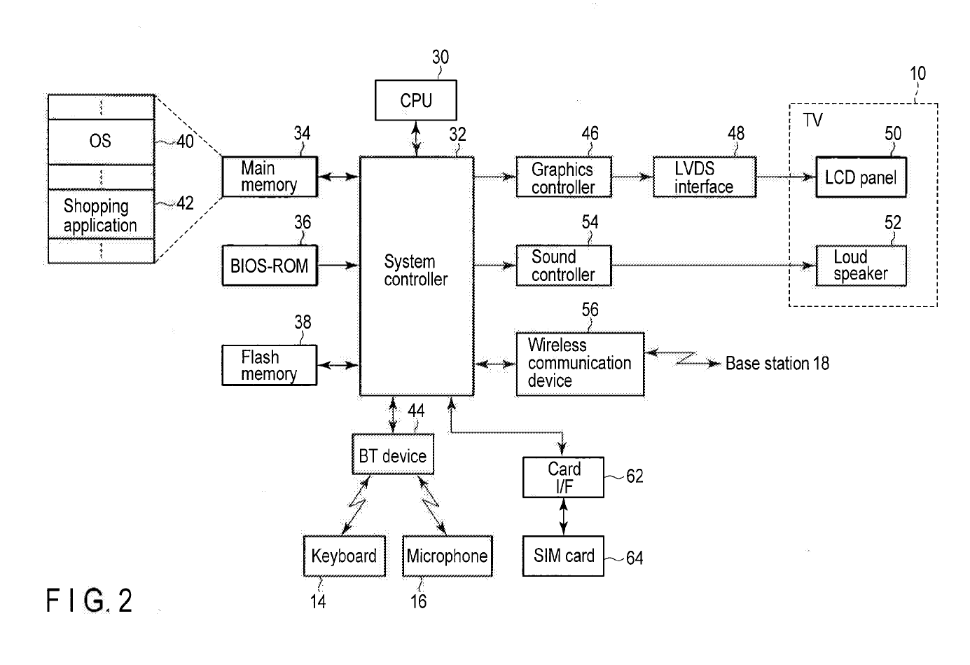

FIG. 2 is a block diagram showing an example of the configuration of the electronic device 12. As shown, the electronic device 12 includes a CPU 30, a system controller 32, a main memory 34, a BIOS-ROM 36, a flash memory 38, a graphics controller 46, a sound controller 54, a wireless communication device 56, a Bluetooth device 44, a card I/F 62, etc.

The CPU 30 is a processor for controlling the operations of various modules. The CPU 30 executes various types of software loaded from the flash memory 38 onto the main memory 34. This software includes an operating system (OS) 40, a shopping application program 42, etc.

The CPU 30 also executes a basic input output system (BIOS) stored in the BIOS-ROM 36. The BIOS is a program for hardware control.

The system controller 32 is a device that connects the CPU 30 to each module. The system controller 32 includes a memory controller for performing access control of the main memory 34. The system controller 32 is connected to the main memory 34, the BIOS-ROM 36, the flash memory 38, the graphics controller 46, the sound controller 54, the wireless communication device 56, the Bluetooth device 44, etc.

The graphics controller 46 controls an LCD panel 50 incorporated in the digital television receiver 10, via an LVDS interface 48. The graphics controller 46 sends a screen signal to the LCD panel 50 under the control of the CPU 30. The LCD panel 50 displays various graphic user interface (GUI) screens based on screen signals.

The sound controller 54 processes voice signals, and generates a guidance voice signal to be output through a loudspeaker 52 incorporated in the digital television receiver 10.

The wireless communication device 56 is configured to perform wireless communication, such as wireless LAN communication and 3G mobile communication, or near field communication (NFC). The electronic device 12 is connected to the Internet 20 via the wireless communication device 56.

A card I/F 62 is used to connect an SIM card 64 to the system controller 32. The SIM card 64 is an IC card that records a unique ID number for identifying a phone number used for mobile communication.

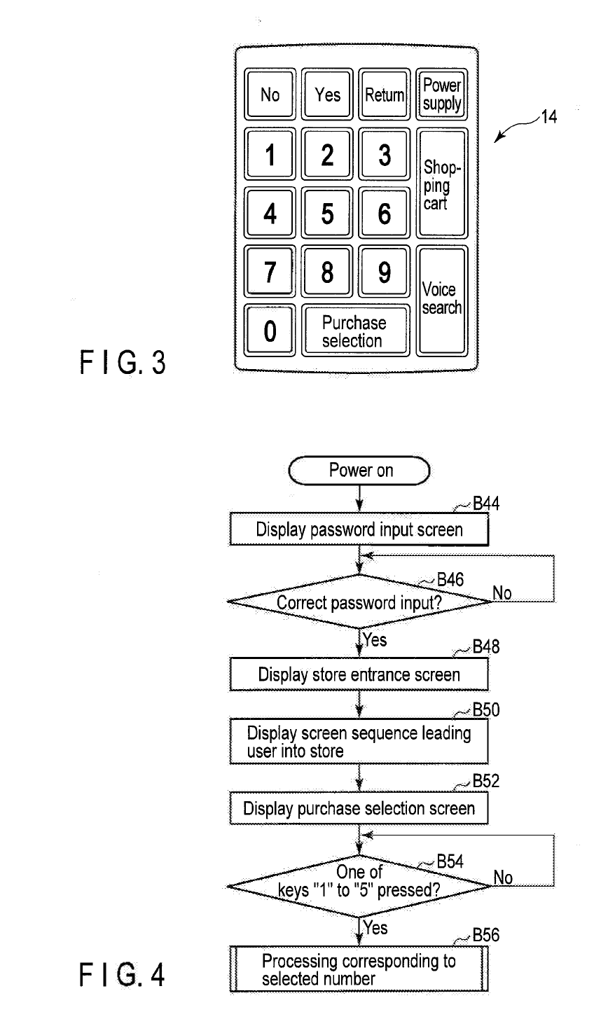

The Bluetooth device 44 is connected to the wireless keyboard 14 and the wireless microphone 16. The wireless keyboard 14 is used to select various options displayed on the screen using, for example, a numeral key, and to input various commands. FIG. 3 shows an example of the key arrangement of the wireless keyboard 14. As shown, the wireless keyboard 14 includes numerical keys ranging from “0” to “9,” and keys of a “NO” key, a “YES” key, a “return” key, a “power supply” key, a “shopping cart” key, a “voice search” key and a “purchase selection” key. The numerical keys are used to, for example, select an option. The “NO” key and the “YES” key are used to, for example, respond to a confirmation message displayed on the screen. The “return” key is used to return the screen or operation to the preceding one. The “return” key is accepted in an arbitrary screen. The “power supply” key is used to turn on and off the electronic device 12. The “shopping cart” key is used to, for example, confirm an article decided to be purchased, and to pay money for the purchased article(s) (also referred to “to settle” the purchased article(s)). The “shopping cart” key is unacceptable before a purchase selection screen, described later, is displayed, and is acceptable on any screen after the purchase selection screen is displayed. The “voice search” key is used to, for example, order an article through voice. The “voice search” key is unacceptable before the purchase selection screen is displayed, and is acceptable on any screen after the purchase selection screen is displayed. The “purchase selection” key is used to select, for example, the way of shopping. The “purchase selection” is unacceptable before the purchase selection screen is displayed, and is acceptable on any screen after the purchase selection screen is displayed.

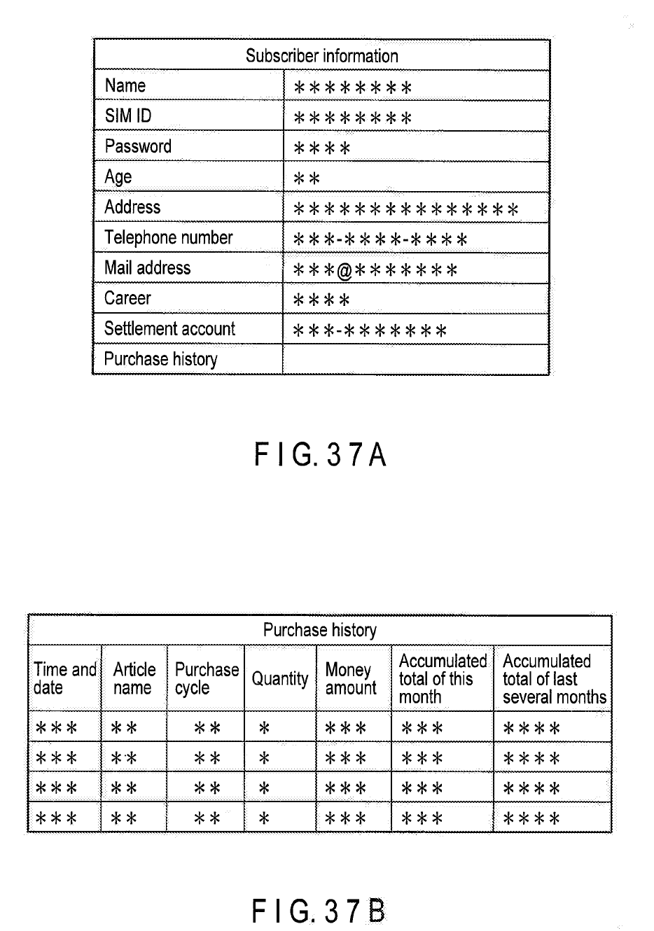

The Internet shopping service provider distributes the electronic device 12 to each user. A setting for accessing the server 22 of the service provider is already set in the electronic device 12. In general personal computers, various settings are needed for Internet connection. In contrast, in the case of the electronic device 12, it is sufficient if a particular server 22 is accessed, and hence a setting for connection can be made beforehand. However, each user is required to register as a subscriber with the service provider before being served. For registration of a subscriber, each subscriber creates subscriber information (their name, SIM card ID, password, age, sex, address, phone number, mail address, career, settlement account, purchase history) as shown in FIG. 37A. Note that since the SIM card ID is directly read from the SIM card 64, the user does not have to input it. The password is used to identify the user, and includes an arbitrary 4-digit number input by the user. Accordingly, a single electronic device 12 (with the same SIM ID) can be shared by the family members of the user if they use different passwords. The purchase history includes time and date, article name, article purchasing cycle, number of articles, amount of money, one-month sum total, multi-month sum total, etc., and are updated whenever purchasing is made. Thus, a purchase history indicating what was purchased, when it was purchased, how many articles were purchased, and how much they cost is recorded for each subscriber. Since the purchase history records the article(s) purchased on the day or within last several days, it can prevent unintentional duplicate purchasing of any article. Since the purchase history also records the total of the articles purchased this month, and that of the articles purchased within the last several months, excessive purchasing can be prevented beforehand. The subscriber information is often stored in the server 22. However, it may be stored in the electronic device 12.

FIG. 4 is an outline flowchart of an example of net (online) shopping carried out after subscriber registration.

Upon detecting the operation of the “power supply” key on the keyboard 14, the electronic device 12 is turned on to activate the shopping application. At the same time, the CEC function of HDMI is used through the HDMI cable to turn on the television receiver 10 so as to enable the LCD panel 50 to display a display signal from the electronic device 12.

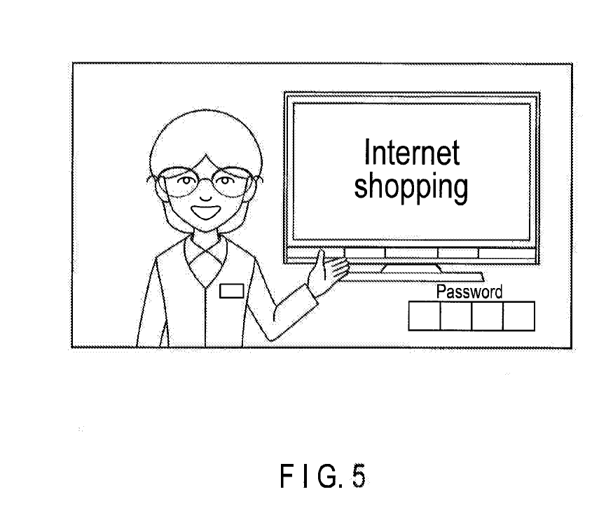

Upon activation of the shopping application, a password input screen is displayed in block B44 as shown in FIG. 5. The password input screen displays a cartoon character as a net shopping operator, a subtitle “Internet shopping,” and a password input frame. A user inputs their password of four digits using numeral keys of the keyboard 14. In general identification, a user ID and a password are input and verified. However, in the embodiment, an SIM ID is used as the user ID, and hence the input of the user ID is not needed. The input password and the SIM ID are sent from the electronic device 12 to the server 22, whereby identification is performed based on subscriber information stored in the server 22. Since thus, the input of the user ID is set unnecessary, no character keys are needed on the keyboard. As a result, net shopping is realized by simple operation of a simple remote controller with only numbers. This enables even the persons who are not familiar with the operation of personal computers to utilize net shopping. Further, the user ID is the SIM ID, which means that the same user ID (=SIM ID) can be shared between the family members of the user, and that the same electronic device 12 can be used in common by the family members if different passwords are set for the members.

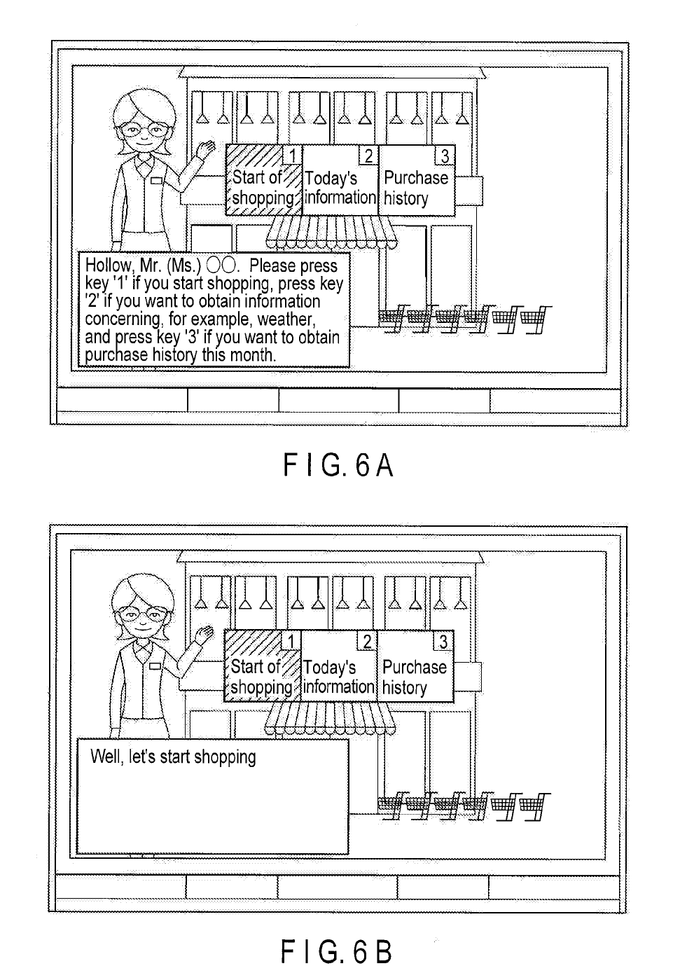

When the password has been verified (when identification is made) in block B46, such a store entrance screen as shown in FIG. 6A is displayed in block B48. The store entrance screen displays a cartoon character as a net shopping operator, and the outward appearance of the supermarket. This screen also displays key numbers with operations to be performed when the keys have been pressed, i.e., “1: Start of shopping, 2: Today's information, 3: Purchase history,” and a message “Hollow, Mr. (Ms.) xxxx,” followed by “Please press key ‘1’ if you start shopping, press key ‘2’ if you want to obtain information concerning, for example, weather, and press key ‘3’ if you want to obtain purchase history this month.” Simultaneously with the above display, the sound controller 54 generates a guidance voice message “Hollow, Mr. (Ms.) xxxx,” followed by “Please press key ‘1’ if you start shopping, press key ‘2’ if you want to obtain information concerning, for example, weather, and press key ‘3’ if you want to obtain purchase history this month.” Since thus, a message is displayed on the display and is output as a voice message through a loudspeaker, even a user who is unfamiliar with mechanical operations can easily understand the operations.

Note that the guidance voice message is not required for all users, and therefore that the embodiment may be modified such that whether or not the guidance voice message is necessary can be registered for each user as part of subscriber information. Yet alternatively, whether or not the guidance voice message is necessary may be set for each scene of shopping.

In addition, the displayed message is not needed for all users. Therefore, whether or not the displayed message is necessary may be registered for each user as part of subscriber information or for each scene of shopping. If the displayed message is eliminated, the article image display area can be enlarged, thereby enhancing the convenience of article selection.

Selective turn on of the guidance voice message and the displayed message can reduce the degree of annoying.

Furthermore, since key numbers with information concerning the operations to be performed when the keys have been pressed, are displayed, which key of the keyboard should be pressed can be easily detected.

When a user presses the key “1,” the store entrance screen is changed to that shown in FIG. 6B. Namely, in FIG. 6B, a message “Well, let's start shopping” is displayed, instead of the message of FIG. 6A, “Hollow, Mr. (Ms.) xxxx,” followed by “Please press key ‘1’ if you start shopping, press key ‘2’ if you want to obtain information concerning, for example, weather, and press key ‘3’ if you want to obtain purchase history this month.” At the same time, the sound controller 54 generates a guidance voice message “Well, let's start shopping,” which is output through the loudspeaker 52. Further, when the key “1” has been pressed, the display state (e.g., color) of “1: Start of shopping” corresponding to this key is changed. As a result, the selected key can be easily understood.

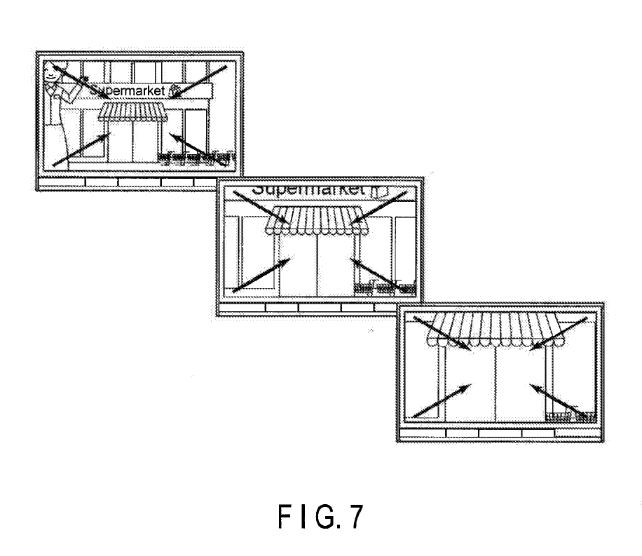

In block B50, a screen sequence leading the user into the store is displayed as shown in FIG. 7. In the screen sequence, the appearance of the inlet of the supermarket is gradually increased in scaling factor. For instance, three still images are switched from one to another every 0.5 seconds. This enables virtual experience of entering the supermarket, which imparts a sense of realism to mechanical net shopping.

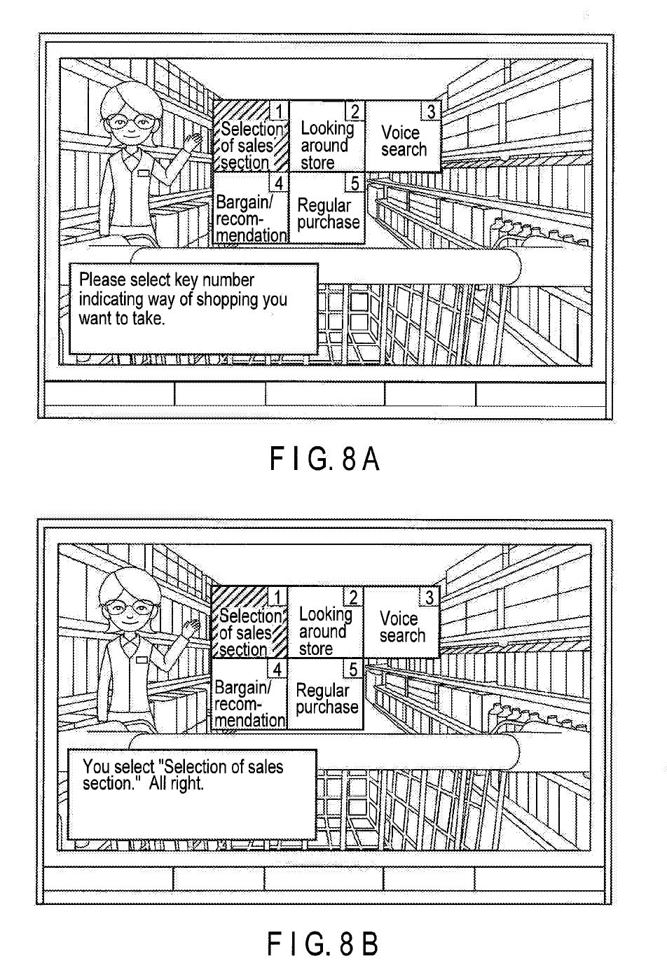

In block B52, a purchase selection screen as shown in FIG. 8A is displayed. The purchase selection screen displays a cartoon character as a net shopping operator, and the indoor scenery of the supermarket. This screen also displays key numbers with operations to be performed when the keys have been pressed, i.e., “1: Selection of sales section(s), 2: Looking around store, 3: Voice search, 4: Bargain/recommendation, 5: Regular purchase,” and a message “Please select a key number indicating the way of shopping you want to take.” Simultaneously with this display, the sound controller 54 generates a guidance voice message “Please select a key number indicating the way of shopping you want to take,” and outputs it through the loudspeaker 52.

The user selects one of the ways of shopping displayed on the screen to thereby press one of the keys “1” to “5” corresponding to the selected way. Upon detecting the operation of one of the keys “1” to “5” in block B54, processing corresponding to the selected key is performed in block B56.

If the user has already decided articles to buy at various sales sections, they select “1: Selection of sales section(s),” while if they have not yet decided them and want to look around the store in order to decide articles to buy, they select “2: Looking around store.” Further, if they want to utilize voice search using keywords, such as article names, they select “3: Voice search,” if they have not yet decided articles to buy and want to see a good or recommended buy, they select “4: Bargain/recommendation,” and if they want to buy articles regularly bought so far, they select “5: Regular purchase.”

When the key “1” has been pressed, the purchase selection screen is changed to that shown in FIG. 8B. Namely, in FIG. 8B, a message “You select ‘1: Selection of sales section(s).’ All right.” is displayed instead of the message “Please select a key number indicating the way of shopping you want to take” shown in FIG. 8A. At the same time, the sound controller 54 generates a guidance voice message “you select ‘1: Selection of sales section(s),’ all right.” and outputs it through the loudspeaker 52.

If “2: Today's information on, for example, weather” is selected on the store entrance screen, information from the server 22 of the net shopping is displayed. If “3: Purchase history” is selected, a purchase history for each day (or month) or for each article is displayed based on the subscriber information of the user in the server 22.

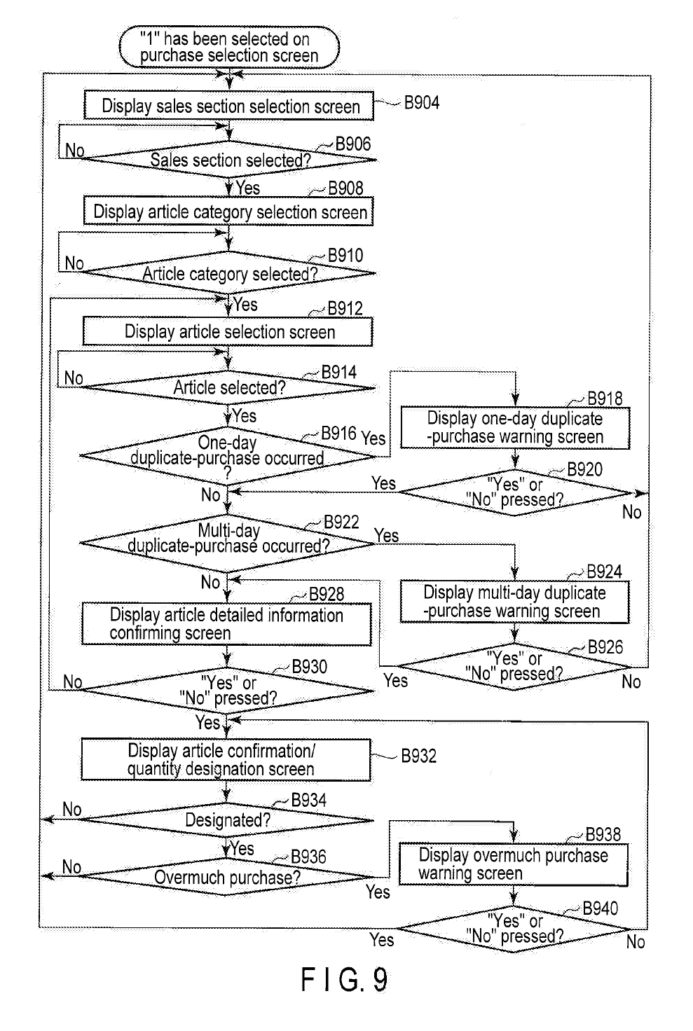

FIG. 9 is a flowchart of an example of the process performed after “1: Selection of sales section” is selected on the purchase selection screen of FIG. 8A.

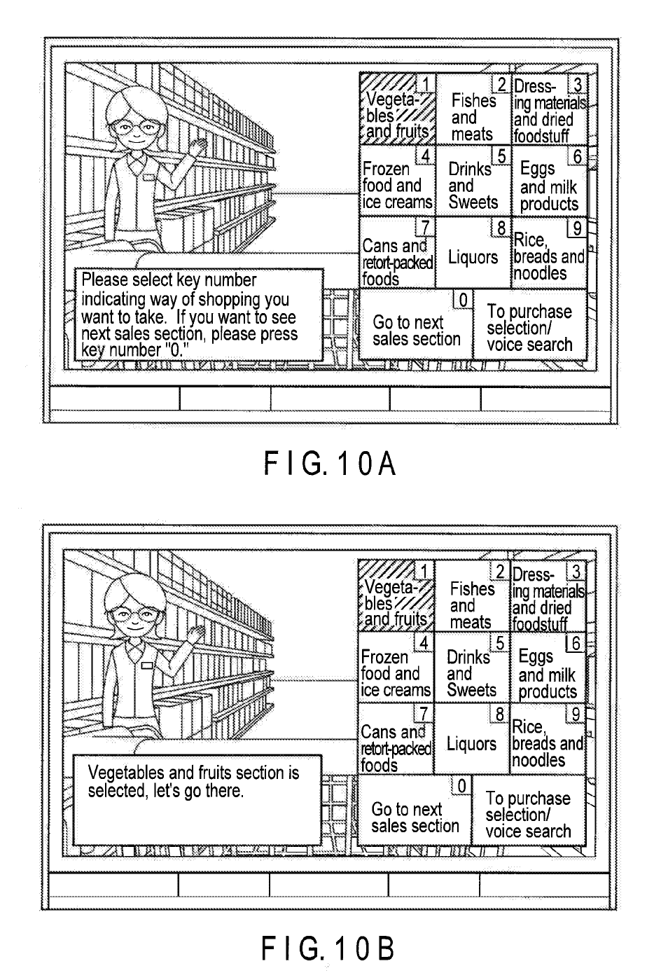

In block B904, a sales section selection screen as shown in FIG. 10A is displayed. The sales section selection screen displays the indoor scenery of the supermarket and a cartoon character as a net shopping operator. This screen also displays key numbers with the content of sales sections as options, i.e., “1: Vegetables and fruits, 2: Fishes and meats, 3: Dressing materials and dried foodstuff, 4: Frozen food and ice creams, 5: Drinks and Sweets, 6: Eggs and milk products, 7: Cans and retort-packed foods, 8: Liquors, 9: Rice, breads and noodles, 0: Go to next sales section, to purchase selection/voice search,” and a message “Please select a key number indicating the way of shopping you want to take,” followed by “If you want to see the next sales section, please press key number 0.” Simultaneously with this display, the sound controller 54 generates a guidance voice message “Please select a key number indicating the way of shopping you want to take,” followed by “If you want to see the next sales section, please press key number 0,” and outputs it through the loudspeaker 52. The cartoon character may be of a moving image, instead of a still image.

The user selects the one of the displayed sales sections, at which an article they want to buy may exist, and presses one of the keys “1” to “9” corresponding thereto. Upon detecting in block B906 that one of the keys “1” to “9” has been pressed, the sales section selection screen is changed to that shown in FIG. 10B. Namely, a message “Vegetables and fruits section is selected, let's go there” is displayed instead of the message “Please select a key number indicating the way of shopping you want to take,” followed by “If you want to see the next sales section, please press key number 0.” At the same time, the sound controller 54 generates a guidance voice message “Vegetables and fruits section is selected, let's go there,” and outputs it through the loudspeaker 52.

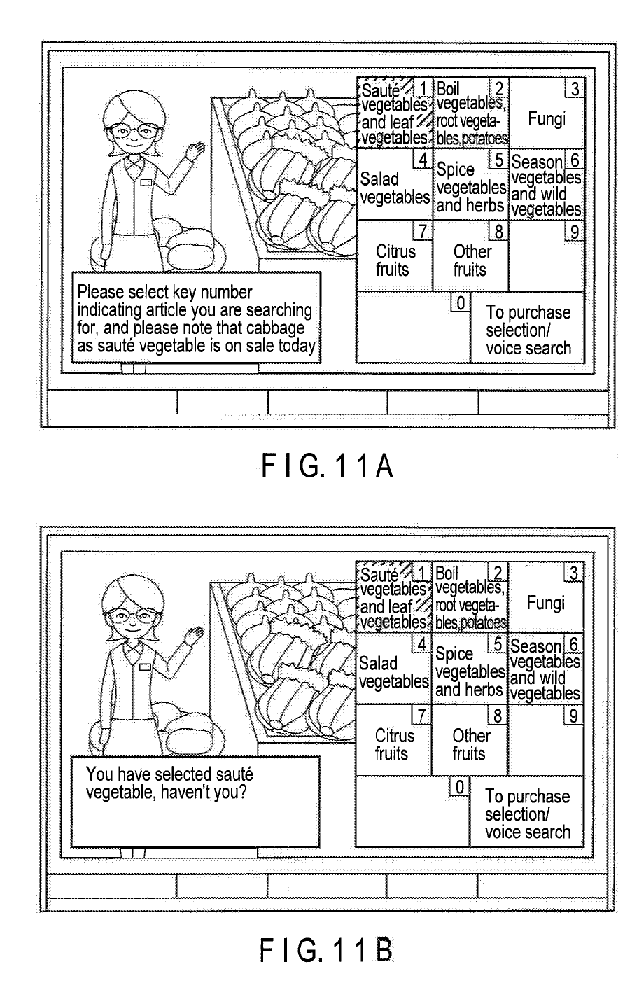

After that, in block B908, an article category selection screen as shown in FIG. 11A is displayed. The article category selection screen displays the scenery of the sales section, and a cartoon character as a net shopping operator. This screen also displays key numbers with categories as options, i.e., “1: Sauté vegetables and leaf vegetables, 2: Boil vegetables, root vegetables, potatoes, 3: Fungi, 4: Salade vegetables, 5: Spice vegetables and herbs, 6: Season vegetables and wild vegetables, 7: Citrus fruits, 8: Other fruits, and to purchase selection/voice search, and a message “Please select a key number indicating the article you are searching for, and please note that cabbage as a sauté vegetable is on sale today.” Simultaneously with this display, the sound controller 54 generates a guidance voice message “Please select a key number indicating the article you are searching for, and please note that cabbage as a sauté vegetable is on sale today.”

The user selects, from the article categories displayed on the screen, the category to which an article they want to buy belongs, and presses the one of the keys “1” to 8” that corresponds thereto. In the description below, suppose that “1: Sauté vegetables and leaf vegetables” has been selected. Upon detecting, in block B910, that one of the keys “1” to “8” has been pressed, the article category selection screen is changed to that shown in FIG. 11B. Namely, in FIG. 11B, a message “you have selected a sauté vegetable, haven't you?” is displayed, instead of the message, shown in FIG. 11A, “Please select a key number indicating the article you are searching for, and please note that cabbage as a sauté vegetable is on sale today.” At the same time, the sound controller 54 generates a guidance voice message “you have selected a sauté vegetable, haven't you?” and outputs it through the loudspeaker 52.

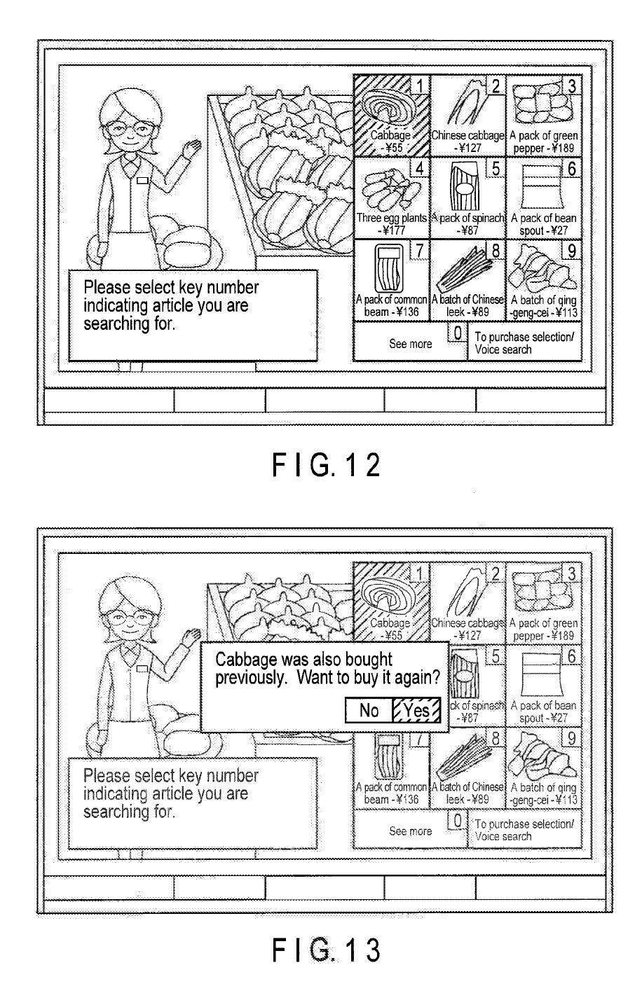

At the next block B912, an article selection screen corresponding to “1: Sauté vegetables and leaf vegetables” is displayed as shown in FIG. 12. The article selection screen displays the scenery of the sales section, and a cartoon character as a net shopping operator. This screen also displays key numbers with vegetable names and prices, i.e., “1: Cabbage—55 yen, 2: Chinese cabbage—127 yen, 3: A pack of green pepper—189 yen, 4: Three egg plants—177 yen, 5: A pack of spinach—87 yen, 6: A pack of bean spout—27 yen, 7: A pack of common beam—136 yen, 8: A batch of Chinese leek—89 yen, 9: A batch of qing-geng-cei—113 yen, 0: See more, to Purchase selection/Voice search,” and a message “Please select a key number indicating the article you are searching for, and please note that cabbage as a sauté vegetable is on sale today.” Simultaneously with this display, the sound controller 54 generates a guidance voice message “Please select a key number indicating the article you are searching for, and please note that cabbage as a sauté vegetable is on sale today” and outputs it through the loudspeaker 52.

When displaying articles on the screen, online store article information stored in a database, article categories, and the purchase history of the user are acquired to classify and rank the article categories, thereby displaying the ranking information. As a result, the probability of selection of “0: See more” becomes least on the article selection screen. Thus, the number of selection steps for the user can be reduced. Further, number “1” may be set as a default on the selection screen, and be changed to another number only when it should be changed.

The user selects the one of the articles on the screen that they want to buy, and presses the corresponding one of the keys “1” to “9.” If it is determined in block B914 that a certain article has been selected by pressing one of the keys “1” to “9,” it is determined in block B916 whether one-day duplicate-purchase has occurred. “One-day duplicate-purchase” means that the user unintentionally attempts to repetitively buy the same or similar articles on the current day. The “similar articles” mean articles regarded as the same articles although they were produced by different makers or have different sizes (suppose, for example, orange juice). In actual shopping, articles are actually picked up and placed into a shopping cart, and hence the same thing is seldom purchased twice. In the online shopping, however, since articles are purchased simply by pressing a key, duplicate purchase of the same or similar article may not be noticed. To avoid this, it is determined referring to the purchase history of the user whether one-day duplicate-purchase has occurred. Assume here that the key “1” has been pressed while seeing the article selection screen to thereby select cabbage. If one-day duplicate-purchase has occurred, a one-day duplicate-purchase warning screen is displayed at block B918 as shown in FIG. 13. As shown, on the one-day duplicate-purchase warning screen, the article selection screen shown in FIG. 12 is blurred, and a message “Cabbage was also bought previously,” followed by “Want to buy it again?” with options “Yes/No” is displayed on the blurred screen. At the same time, the sound controller 54 generates a guidance voice message “Cabbage was also bought previously,” followed by “Want to buy it again?” and “Please press the ‘Yes’ or ‘No’ key,” and outputs it through the loudspeaker 52.

If it is determined in block B920 that the No key has been pressed, the order of cabbage is canceled, and the screen is returned to the sales section selection screen (shown in FIG. 10A) in block B904. In contrast, if it is determined in block B920 that the “Yes” key has been pressed, the order is decided and the program proceeds to the subsequent process. Further, when neither of the “Yes” or No key has been pressed, it may be considered that the “Yes” key has been pressed, and the program may proceed to the subsequent process, after the one-day duplicate-purchase warning screen is displayed for a predetermined period.

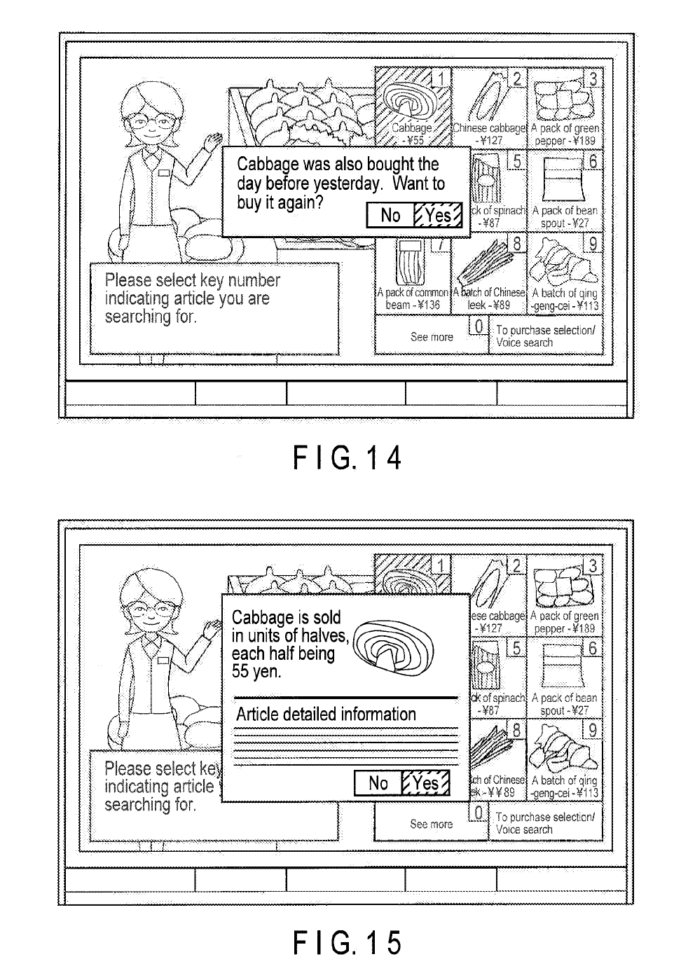

In block B922, it is determined whether multi-day duplicate-purchase has occurred. The “multi-day duplicate-purchase” means that the user unintentionally attempts to repetitively buy the same or similar article as or to that bought within the last several days. Referring to the purchase history of the user, it is determined whether multi-day duplicate-purchase has occurred. If multi-day duplicate-purchase is determined to have occurred, a multi-day duplicate-purchase warning screen is displayed as shown in FIG. 14. As shown, on the multi-day duplicate-purchase warning screen, the article selection screen shown in FIG. 12 is blurred, and a message “Cabbage was also bought yesterday,” followed by “Want to buy it again?” with options “No/Yes” is displayed. At the same time, the sound controller 54 generates a guidance voice message “Cabbage was also bought yesterday. Want to buy it again? Please press the ‘Yes’ or ‘No’ key,” and outputs it through the loudspeaker 52.

If it is determined in block B926 that the No key has been pressed, the order of cabbage is canceled, and the screen is returned to the sales section selection screen (shown in FIG. 10A) in block B904. In contrast, if it is determined that the “Yes” key has been pressed, the order is decided and the program proceeds to the subsequent process. Further, when neither of the “Yes” or No key has been pressed, it may be considered that the “Yes” key has been pressed, and the program may proceed to the subsequent process, after the multi-day duplicate-purchase warning screen is displayed for a predetermined period.

In block B928, such an article detailed information confirming screen as shown in FIG. 15 is displayed. On the article detailed information confirming screen, the article selection screen shown in FIG. 12 is blurred, and a message “Cabbage is sold in units of halves, each half being 55 yen,” followed by “Article detailed information . . . with options “No/Yes” is displayed on the blurred screen. At the same time, the sound controller 54 generates a guidance voice message “Cabbage is sold in units of halves, each half being 55 yen,” followed by “Article detailed information is . . . ” and “Please press the ‘Yes’ or ‘No’ key,” and outputs it through the loudspeaker 52.

If it is determined in block B930 that the No key has been pressed, the order of cabbage is canceled, and the screen is returned to the article selection screen (shown in FIG. 12) in block B912. In contrast, if it is determined that the “Yes” key has been pressed, the order is decided and the program proceeds to the subsequent process.

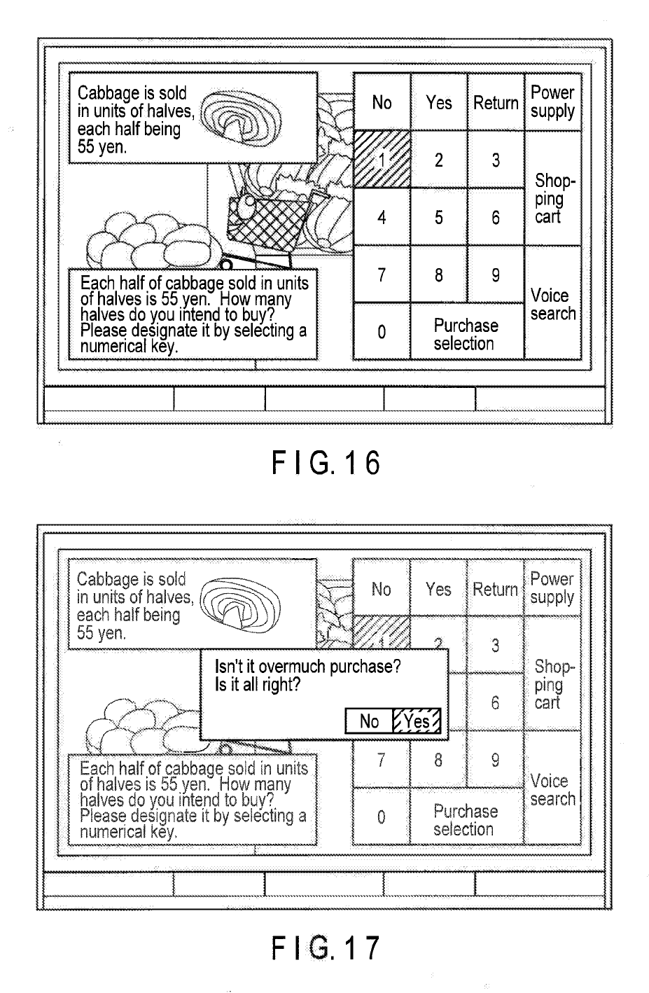

At step B932, such an article confirmation/quantity designation screen as shown in FIG. 16 is displayed. The article confirmation/quantity designation screen displays the scenery of the sales section, an article explanation message “Cabbage is sold in units of halves, each half being 55 yen,” a message “Each half of cabbage sold in units of halves is 55 yen,” followed by “How many halves do you intend to buy?” and “Please designate it by selecting a numerical key,” and keys corresponding to the keys of the keyboard 14. At the same time, the sound controller 54 generates a guidance voice message “Each half of cabbage sold in units of halves is 55 yen,” followed by “How many halves do you intend to buy?” and “Please designate it by selecting a numerical key,” and outputs it through the loudspeaker 52.

The user designates the article quantity by pressing the corresponding numerical key. The minimum value of the article quantity may be set as a default value, and the article quantity be designated only when it is changed (increased). Upon detecting in block B934 that one of the numerical keys “1” to “9” has been pressed to designate the article quantity, it is determined in block B936 whether overmuch purchase has been made. In actual shopping, articles are actually picked up and placed into a shopping cart, and hence overmuch purchase can be felt realistically. In the online shopping, however, since articles are purchased simply by pressing a key, a large number key may be unintentionally pressed, resulting in overmuch purchase. To avoid this, it is regarded as overmuch purchase if the designated quantity exceeds a predetermined value. The predetermined quantity may be set for each article or each user. Further, the user may set the article quantity. If it is determined that no overmuch purchase has been made, the program returns to block B904, where the sales section selection screen shown in FIG. 10A is displayed. In contrast, if it is determined that overmuch purchase has been made, such an “overmuch purchase warning screen” as shown in FIG. 17 is displayed in block B938. On the overmuch purchase warning screen, the article confirmation/quantity designation screen shown in FIG. 16 is blurred, and a message “Isn't it overmuch purchase?” followed by “Is it all right?” and “Please press the ‘Yes’ or ‘No’ key” is displayed. At the same time, the sound controller 54 generates a guidance voice message “Isn't it overmuch purchase?” followed by “Is it all right?” and “Please press the ‘Yes’ or ‘No’ key,” and outputs it through the loudspeaker 52.

If it is determined in block B940 that the No key has been pressed, the ordered quantity is canceled, and the screen is returned to the article confirmation/quantity designation screen (shown in FIG. 16) in block B932. In contrast, if it is determined in block B940 that the “Yes” key has been pressed, the order quantity is decided, and the screen is returned to the sales section selection screen (shown in FIG. 10A) in block B904. Further, when neither of the “Yes” or No key has been pressed, it may be considered that the “Yes” key has been pressed, and the program may return to the sales section selection screen in block B904, after the overmuch purchase warning screen is displayed for a predetermined period.

As described above, when “1: Selection of sales section” is selected on the purchase selection screen, the user sequentially selects sales sections of the articles they want to buy, thereby designating the articles and their quantities. Further, as mentioned above, the server 22 manages the purchase history of each user. Therefore, if a user already bought the same article on the same day or within the last several days, the server 22 can inform them of this fact, utilizing screen display and voice output, with the result that duplicate purchase can be avoided. Furthermore, when an article quantity is designated, if it is greater than a predetermined value, the user is informed of the fact through screen display and voice output, whereby unintentional overmuch purchase can be prevented. If the user again makes the same designation after being formed of the above, this designation is accepted.

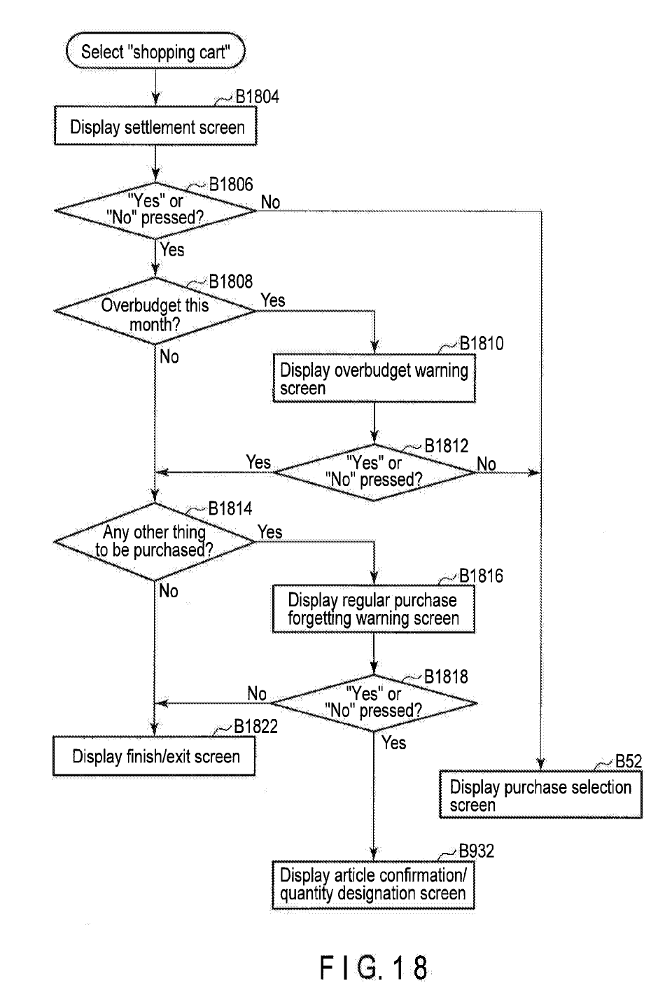

FIG. 18 is a flowchart of an example of the process performed when a “shopping cart” key on the keyboard 14 has been pressed after the display of the purchase selection screen (block B52 of FIG. 4). The “shopping cart” key is pressed when a purchase is finished and a settlement is made.

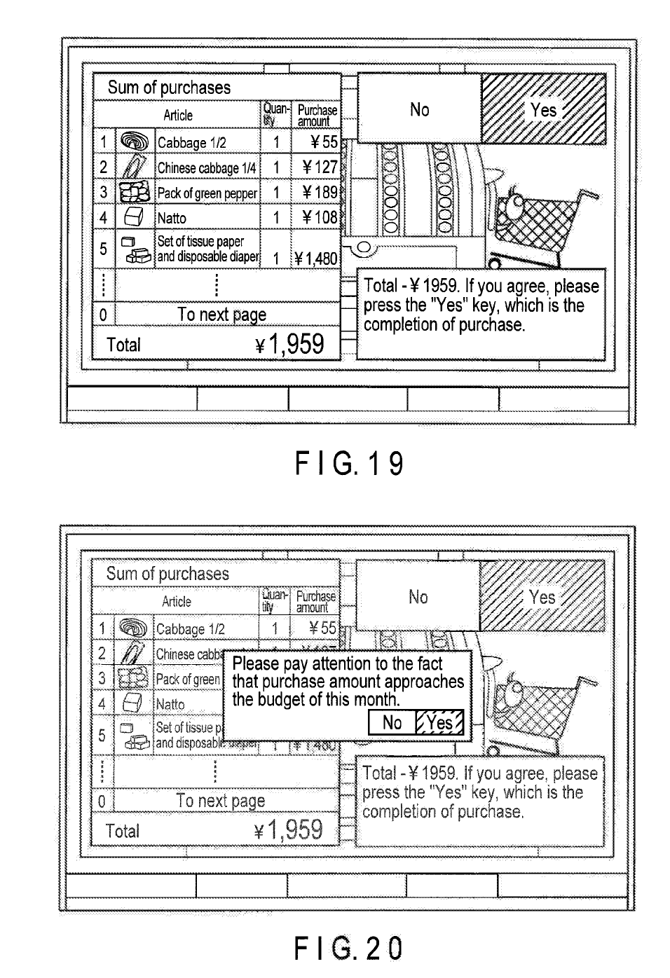

When the “shopping cart” key has been pressed, a settlement screen as shown in FIG. 19 is displayed in block B1804. The settlement screen displays a receipt image showing “Total of purchases, 1: ½ of cabbage—55 yen, 2: ¼ of Chinese cabbage—127 yen, 3: A pack of green pepper—189 yen, 4: One natto—108 yen, 5: A set of tissue paper and paper diaper—1480 yen, Total—1959 yen,” a No key, a “Yes” key, and a message “Total is 1959 yen,” followed by “If you agree, please press the ‘Yes’ key, which is the completion of purchase.” At the same time, the sound controller 54 generates a guidance voice message “Total is 1959 yen,” followed by “If you agree, please press the ‘Yes’ key, which is the completion of purchase,” and outputs it through the loudspeaker 52. If the user wants to cancel a certain article on the settlement screen, they should press the one of the keys “1” to “5” corresponding to the article to cancel.

If it is determined in block B1806 that the No key has been pressed, the settlement processing is canceled, and the program returns to block B52 (shown in FIG. 4) where the purchase selection screen (shown in FIG. 8A) is displayed.

If it is determined in block B1806 that the “Yes” key has been pressed, it is determined in block B1808 whether the purchase of this month is overbudget. If the purchase is determined to be overbudget, an overbudget warning screen is displayed in block B1810. By user setting (not shown), a monthly budget (the upper limit of a purchase amount) can be determined for each user. The budget may vary between months. The total of the purchase amount of this month is determined from the purchase history of a user, and it is determined whether the total exceeds a predetermined percent of the budget, for example, 95%. If the total exceeds 95% of the budget but is still less than the same, such an overbudget warning screen as shown in FIG. 20 is displayed in block B1810. On the overbudget warning screen shown in FIG. 20, the settlement screen shown in FIG. 19 is blurred, and a message “Please pay attention to the fact that the purchase amount approaches the budget of this month,” followed by “Please press the ‘No’ or ‘Yes’ key,” is displayed on the blurred screen. At the same time, the sound controller 54 generates a guidance voice message “Please pay attention to the fact that the purchase amount approaches the budget of this month,” followed by “Please press the ‘No’ or ‘Yes’ key,” and outputs it through the loudspeaker 52.

If the total of the purchase amount exceeds the budget itself, a message “The budget of this month is already exceeded,” followed by “Is it all right?” and “Please press the ‘No’ or ‘Yes’ key” is displayed in block B1810, instead of the message of FIG. 20 “Please pay attention to the fact that the purchase amount approaches the budget of this month,” followed by “Please press the ‘No’ or ‘Yes’ key.”

If it is determined in block B1812 that the No key has been pressed, the settlement processing is canceled, and the program returns to block B52 (shown in FIG. 4) where the purchase selection screen (shown in FIG. 8A) is displayed. In contrast, if it is determined in block B1812 that the “Yes” key has been pressed, a monetary total amount is decided, and the program proceeds to the subsequent processing. Further, when neither of the “Yes” or No key has been pressed, it may be considered that the “Yes” key has been pressed, and the program may proceed to the subsequent process, after the overbudget warning screen is displayed for a predetermined period.

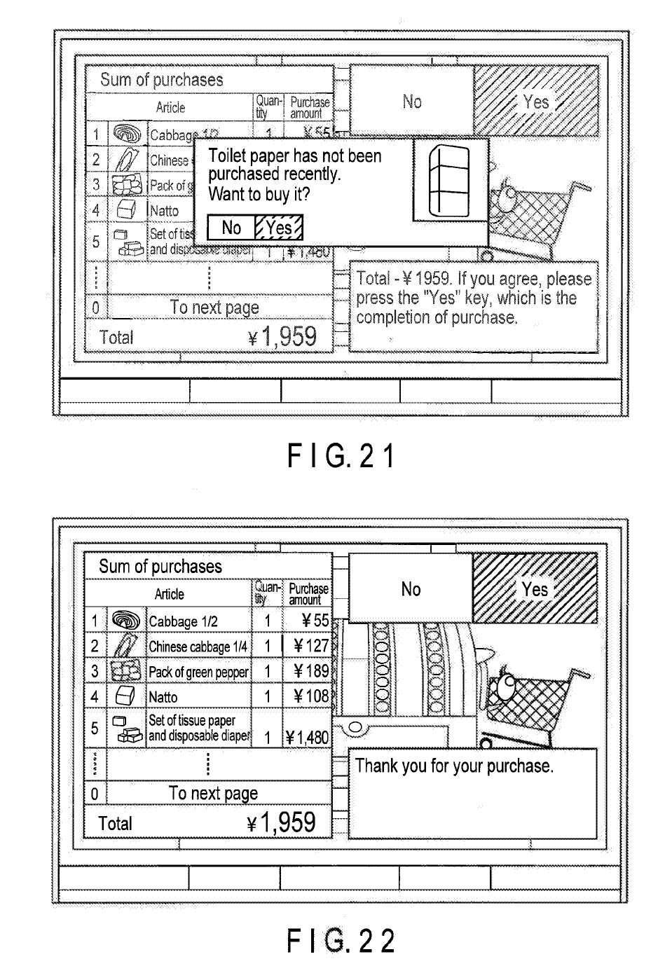

Subsequently, before finishing the settlement, it is determined in block B1814 whether there is any other thing to be purchased. Referring to the purchase history of the user, the end time of use, i.e., the waste time, of an article (for, for example, daily use), namely, the time at which a similar article should be purchased, can be expected. Therefore, if any article that was regularly purchased so far is not purchased even after a period more than the purchase cycle passes, it is considered that there is an article to be purchased now. If such an article is detected, a regular purchase forgetting warning screen as shown in FIG. 21 is displayed in block B1816. On the regular purchase forgetting warning screen, the settlement screen shown in FIG. 19 is blurred, and a message “Toilet paper has not been purchased recently,” followed by “Want to buy it?” with options “Yes/No” is displayed on the blurred screen. At the same time, the sound controller 54 generates a guidance voice message “Toilet paper has not been purchased recently,” followed by “Want to buy it?” and “Please press the ‘Yes’ or ‘No’ key,” and outputs it through the loudspeaker 52.

If it is determined in block B1818 that the No key has been pressed, the settlement is finished, and a finish/exit screen as shown in FIG. 22 is displayed in block B1822. The finish/exit screen displays a receipt image showing “Total of purchases: ½ of cabbage—55 yen, ¼ of Chinese cabbage—127 yen, A pack of green pepper—189 yen, One natto—108 yen, A set of tissue paper and paper diaper—1480 yen, Total—1959 yen,” a No key, a “Yes” key, and a message “Thank you for your purchase.” At the same time, the sound controller 54 generates a guidance voice message “Thank you for your purchase,” and outputs it through the loudspeaker 52.

If it is determined in block B1818 that the “Yes” key has been pressed, the program returns to block B932 (shown in FIG. 9) where the article confirmation/quantity designation screen (shown in FIG. 16) is displayed, thereby enabling toilet paper to be purchased.

Thus, it is determined at the time of settlement whether purchase is overbudget this month or whether there is something that was regularly purchased so far but was forgotten to be purchased this time, thereby informing the user of the determination result by screen display or voice output. As a result, human errors in net (online) shopping can be reduced.

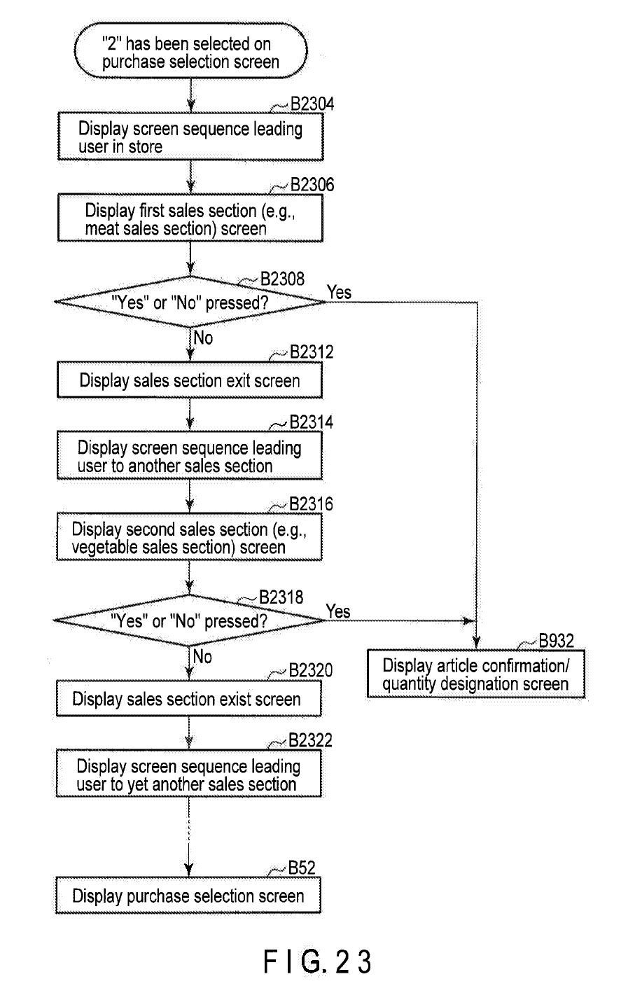

FIG. 23 is a flowchart of an example of the process performed after “2: Looking around store” is selected on the purchase selection screen of FIG. 8.

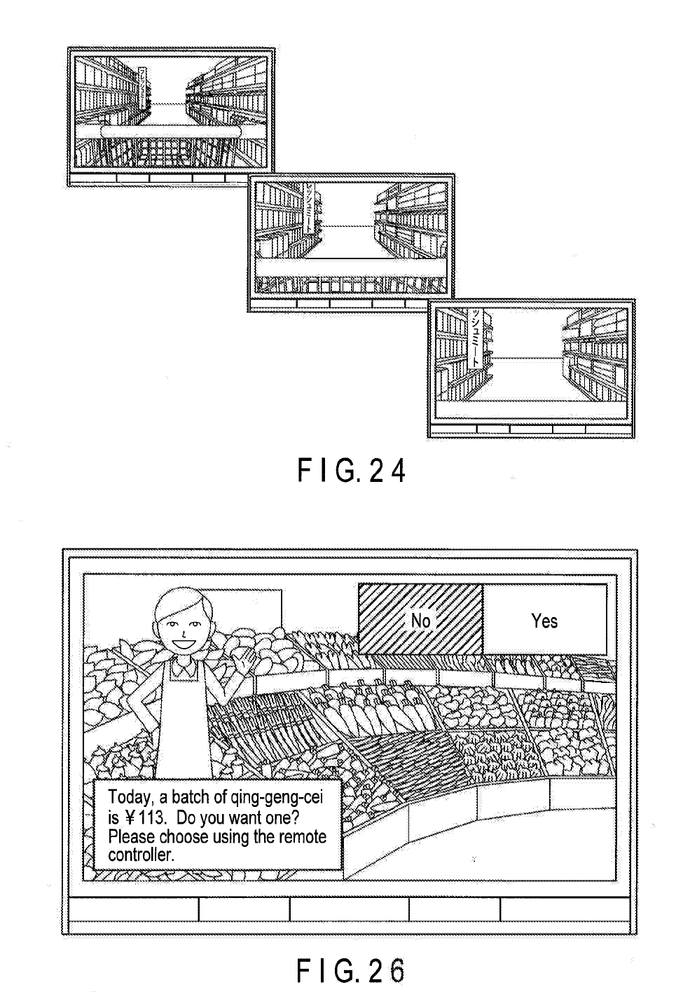

Firstly, in block B2304, a screen sequence leading a user in the store, as shown in FIG. 24, is displayed. On this screen, a scene in which a predetermined sales section in the supermarket is being approached is displayed. More specifically, display of, for example, three still images of gradually increasing magnification factors is sequentially switched in units of 0.5 seconds.

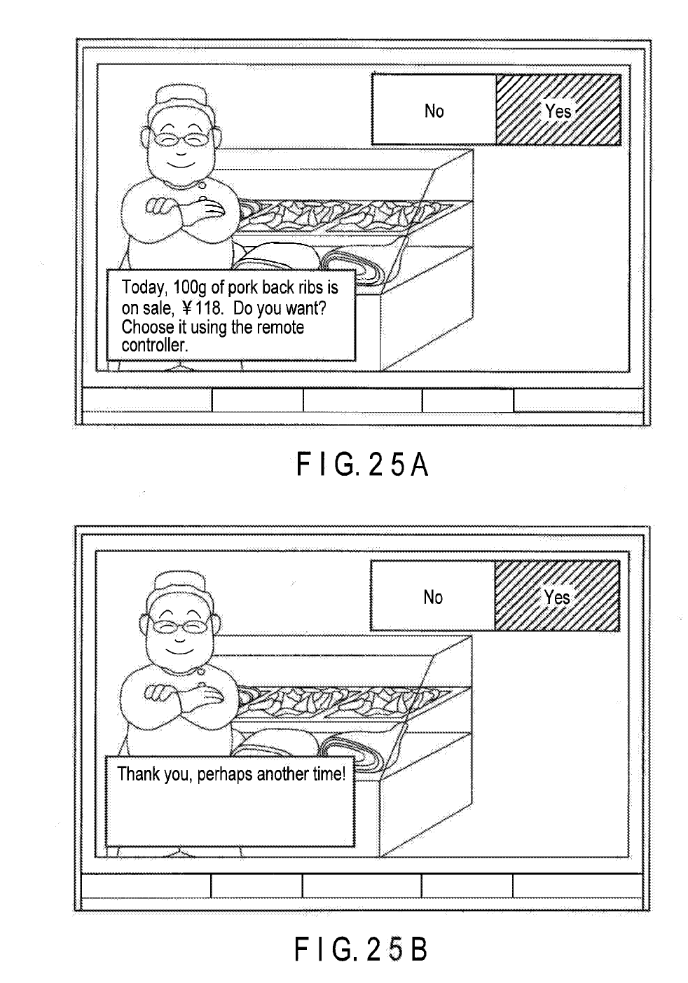

At the next block B2306, a first sales section (e.g., a meat sales section) screen as shown in FIG. 25A is displayed. The meat sales section screen displays the scenery of the meat sales section, a cartoon character as a sales assistant of the meat sales section, a “Yes” key, a No key, and a message “Today, 100 g of pork back ribs is on sale, 118 yen,” followed by “Do you want?” and “Choose it using the remote controller.” At the same time, the sound controller 54 generates a guidance voice message “Today, 100 g of pork back ribs is on sale, 118 yen,” followed by “Do you want?” and “Choose it using a remote controller,” and outputs it through the loudspeaker 52.

If the user wants to buy the pork back ribs, they press the “Yes” key, while if they do not buy anything at the meat sales section, they press the No key. If it is determined in block B2308 that the “Yes” key has been pressed, the program returns to block B932 (shown in FIG. 9) where the article confirmation/quantity designation screen (shown in FIG. 16) is displayed.

In contrast, if it is determined in block B2308 that the No key has been pressed, the meat sales section screen shown in FIG. 25A is changed to such a meat sales section exit screen as shown in FIG. 25B. The meat sales section exit screen displays a message “Thank you, perhaps another time!,” in place of the message in FIG. 25A, “Today, 100 g of pork back ribs is on sale, 118 yen,” followed by “Do you want?” and “Choose it using a remote controller.”

In block B2314, a screen sequence leading a user to another sales section in the supermarket, which is similar to that shown in FIG. 24, is displayed.

In block B2316, a second sales section (e.g., a vegetable sales section) screen as shown in FIG. 26 is displayed. The vegetable sales section screen displays the scenery of the vegetable sales section, a cartoon character as a sales assistant of the vegetable sales section, a “Yes” key, a No key, and a message “Today, a batch of qing-geng-cei is 113 yen,” followed by “Do you want one?” and “Please choose using the remote controller.” At the same time, the sound controller 54 generates a guidance voice message “Today, a batch of qing-geng-cei is 113 yen,” followed by “Do you want one?” and “Please choose using the remote controller,” and outputs it through the loudspeaker 52.

If the user wants to buy the qing-geng-cei, they press the “Yes” key, while if they do not buy anything at the vegetable sales section, they press the No key. If it is determined in block B2318 that the “Yes” key has been pressed, the program returns to block B932 (shown in FIG. 9) where the article confirmation/quantity designation screen (shown in FIG. 16) is displayed.

In contrast, if it is determined in block B2318 that the No key has been pressed, the vegetable sales section screen is changed to a vegetable sales section exit screen. The vegetable sales section exit screen displays a message “Thank you, perhaps another time!” in place of the message “Today, a batch of qing-geng-cei is 113 yen,” followed by “Do you want one?” and “Please choose using the remote controller.”

In block B2322, a screen sequence leading a user to yet another sales section in the supermarket, which is similar to that shown in FIG. 24, is displayed, whereby the above-mentioned processing is iterated.

If the user buys nothing in any of the sales sections, the program returns to block B52 (shown in FIG. 4) where the purchase selection screen (shown in FIG. 8A) is displayed.

As described above, when the user has selected such a way of shopping as “Looking around store,” they do not have to beforehand determine an article to buy, and can detect and buy any desired article while looking around the store. Moreover, they can have a simulated experience of walking around the store and performing net shopping with a sense of realism.

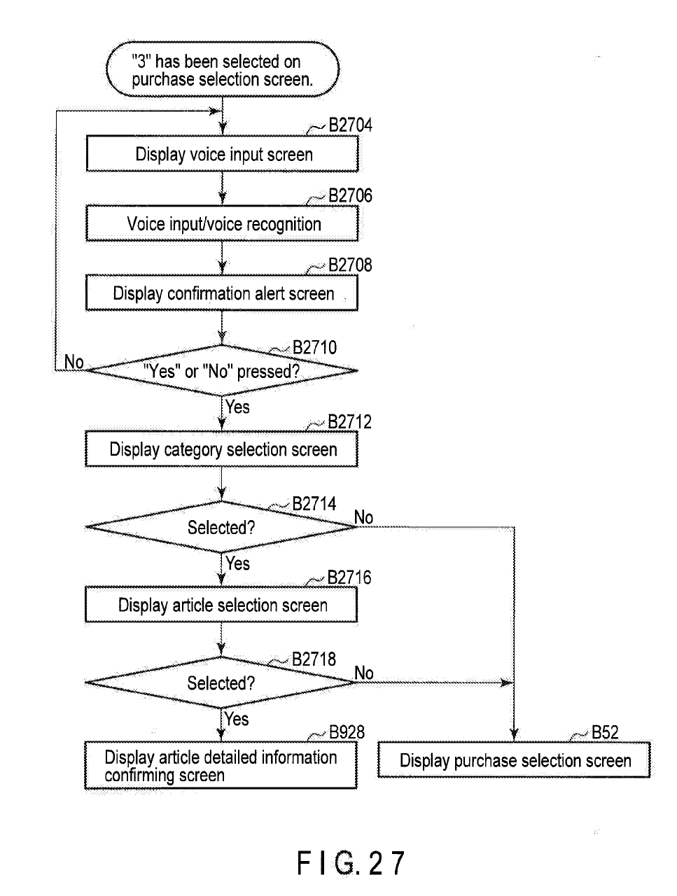

FIG. 27 is a flowchart of an example of the process performed after “3: Voice search” is selected on the purchase selection screen of FIG. 8.

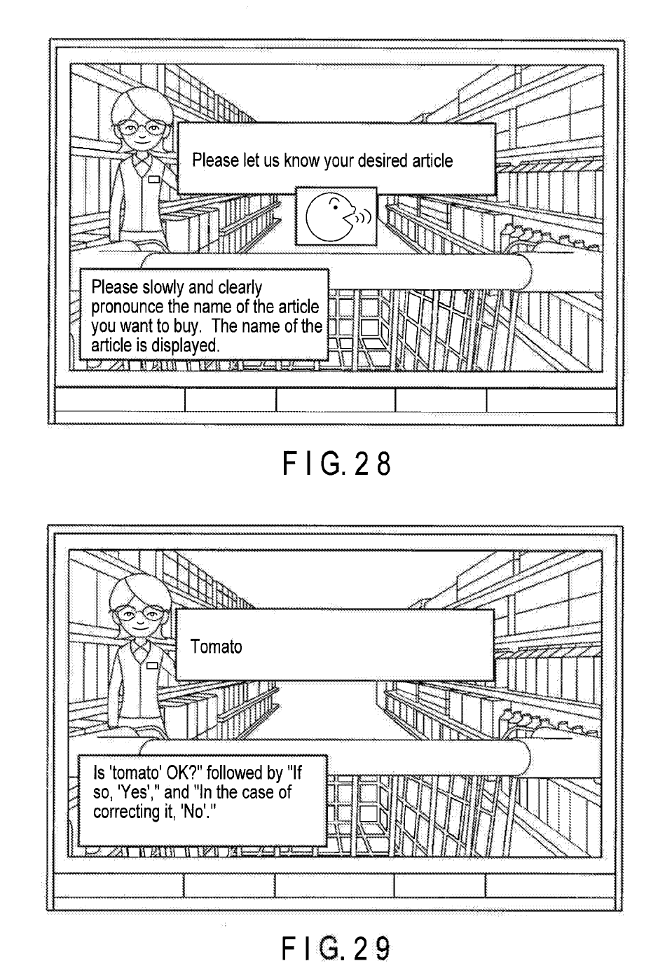

In block B2704, a voice input screen as shown in FIG. 28 is displayed. The voice input screen displays the indoor scenery of the store, a cartoon character as a net shopping operator, a message “Please let us know your desired article,” a message “Please slowly and clearly pronounce the name of the article you want to buy,” followed by “The name of the article is displayed,” and a mark that encourages the user to talk into the microphone. At the same time, the sound controller 54 generates a guidance voice message “Please slowly and clearly pronounce the name of the article you want to buy,” and outputs it through the loudspeaker 52.

In block B2706, the article name sound pronounced by the user is input and subjected to voice recognition processing, whereby the article name is specified. In the voice recognition, the recognition result is compared with a corresponding name stored in a database that stores the names of the articles handled in the online store. If the database stores the corresponding name, this name is presented. In contrast, if the database does not store the corresponding name, the article name most similar to the recognition result is presented as a candidate. This reduces the rate of erroneous recognition.

After finishing the voice recognition, a confirmation alert screen (No. 1) as shown in FIG. 29 is displayed. The confirmation alert screen (No. 1) displays the indoor scenery of the store, a cartoon character as a net shopping operator, a recognition result (in this case, tomato), and a message “Is ‘tomato’ OK?” followed by “If so, ‘Yes’,” and “In the case of correcting it, ‘No’.” At the same time, the sound controller 54 generates a guidance voice message “Is ‘tomato’ OK?” followed by “If so, please say ‘Yes’,” and “In the case of correcting it, please say ‘No’,” and outputs it through the loudspeaker 52.

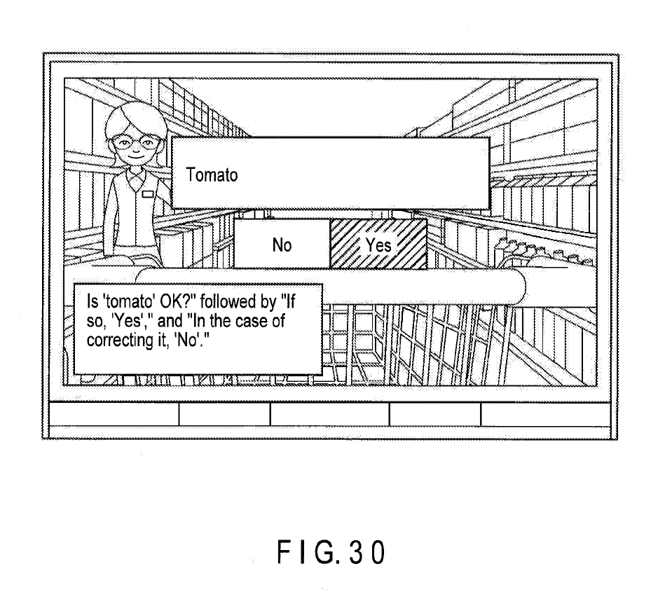

After a predetermined period elapses, a confirmation alert screen (No. 2) as shown in FIG. 30 is displayed in block B2708. The confirmation alert screen (No. 2) displays the indoor scenery of the store, a cartoon character as a net shopping operator, a recognition result (in this case, tomato), a message “Is ‘tomato’ OK?” followed by “If so, ‘Yes’” and “In the case of correcting it, ‘No’,” along with a ‘No’ key and a ‘Yes’ key. At the same time, the sound controller 54 generates a guidance voice message “Is ‘tomato’ OK?” followed by “If so, please press the ‘Yes’ key,” and “In the case of correcting it, please press the ‘No’ key,” and outputs it through the loudspeaker 52.

If it is determined in block B2710 that the No key has been pressed, the program returns to block B2704 where the voice input screen is displayed to enable voice recognition to be executed again.

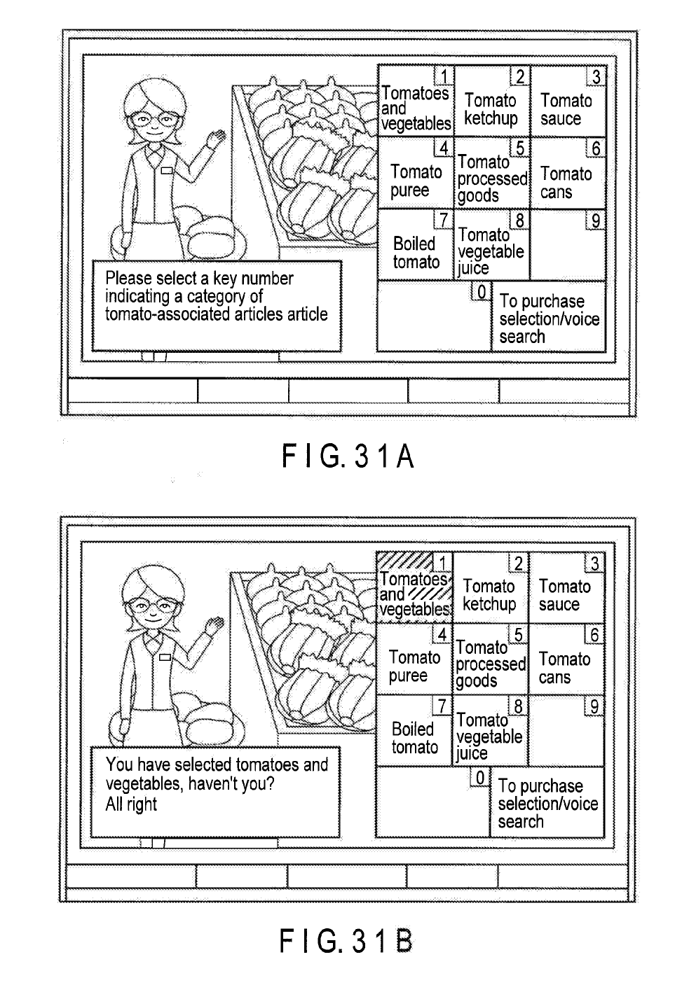

In contrast, if it is determined in block B2710 that the “Yes” key has been pressed, the program proceeds to block B2712 where a category selection screen as shown in FIG. 31A is displayed. The category selection screen displays the scenery of the sales section handling tomatoes, and a cartoon character as a net shopping operator. This screen also displays key numbers with categories, i.e., “1: Tomatoes and vegetables, 2: Tomato ketchup, 3: Tomato sauce, 4: Tomato puree, 5: Tomato processed goods, 6: Tomato cans, 7: Boiled tomato, 8: Tomato vegetable juice, and to purchase selection/voice search,” and a message “Please select a key number indicating a category of tomato-associated articles article.” Simultaneously with this display, the sound controller 54 generates a guidance voice message “Please select a key number indicating a category of tomato-associated articles article,” and outputs it through the loudspeaker 52.

If it is determined in block B2714 that none of the key numbers has been selected, the program returns to block B52 (shown in FIG. 4) where the purchase selection screen (shown in FIG. 8A) is displayed.

If it is determined in block B2714 that one of the key numbers has been selected, the program proceeds to block B2716, where the category selection screen is changed to that shown in FIG. 31B. The screen shown in FIG. 31B displays a message “You have selected tomatoes and vegetables, haven't you?” followed by “All right,” in place of the message “Please select a key number indicating a category of tomato-associated articles” shown in FIG. 31A.

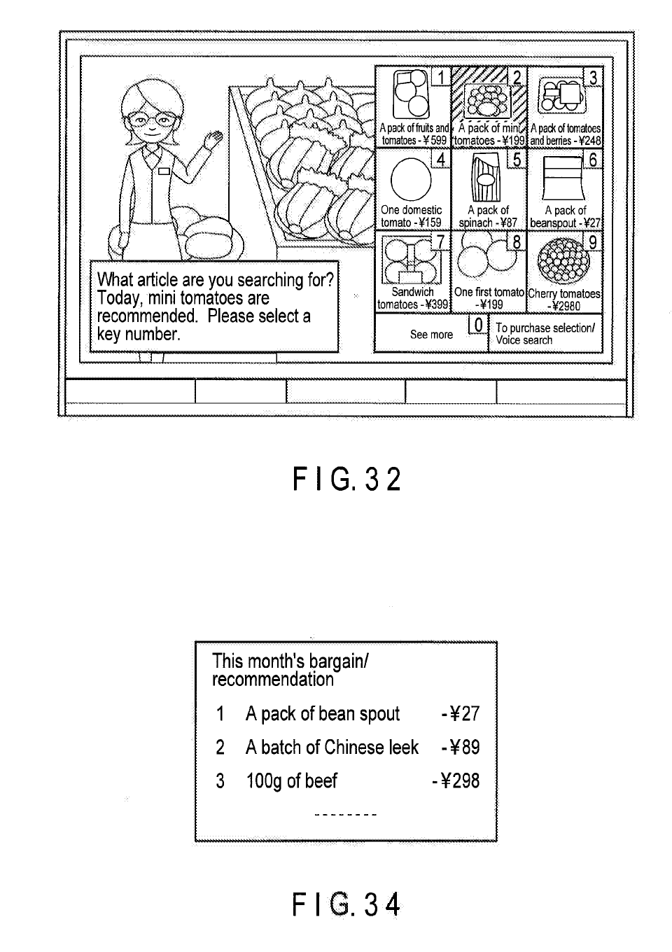

In block B2716, an article selection screen as shown in FIG. 32 is displayed. The article selection screen displays the scenery of the sales section that handles tomatoes and vegetables, and a cartoon character as a net shopping operator. This screen also displays key numbers with categories and prices, i.e., “1: A pack of fruits and tomatoes—599 yen, 2: A pack of mini tomatoes—199 yen, 3: A pack of tomatoes and berries—248 yen, 4: One domestic tomato—159 yen, 5: A pack of spinach—87 yen, 6: A pack of beanspout—27 yen, 7: Sandwich tomatoes—399 yen, 8: One first tomato—199 yen, 9: Cherry tomatoes—2980 yen, 0: See more, to purchase selection/voice search,” and a message “What article are you searching for?” followed by “Today, mini tomatoes are recommended,” and “Please select a key number.” Simultaneously with this display, the sound controller 54 generates a guidance voice message “What article are you searching for?” followed by “Today, mini tomatoes are recommended,” and “Please select a key number,” and outputs it through the loudspeaker 52.

If it is determined in block B2718 that none of the key numbers has been selected, the program returns to block B52 (shown in FIG. 4) where the purchase selection screen (shown in FIG. 8A) is displayed.

In contrast, if it is determined in block B2718 that one of the key numbers has been selected, the program returns to block B928 (shown in FIG. 9) where the article detailed information confirming screen (shown in FIG. 15) is displayed.

Since as described above, an article can be selected simply by inputting its name through voice, a desired article can be bought easily in a short time by voice search if the user knows, for example, the name of the article beforehand.

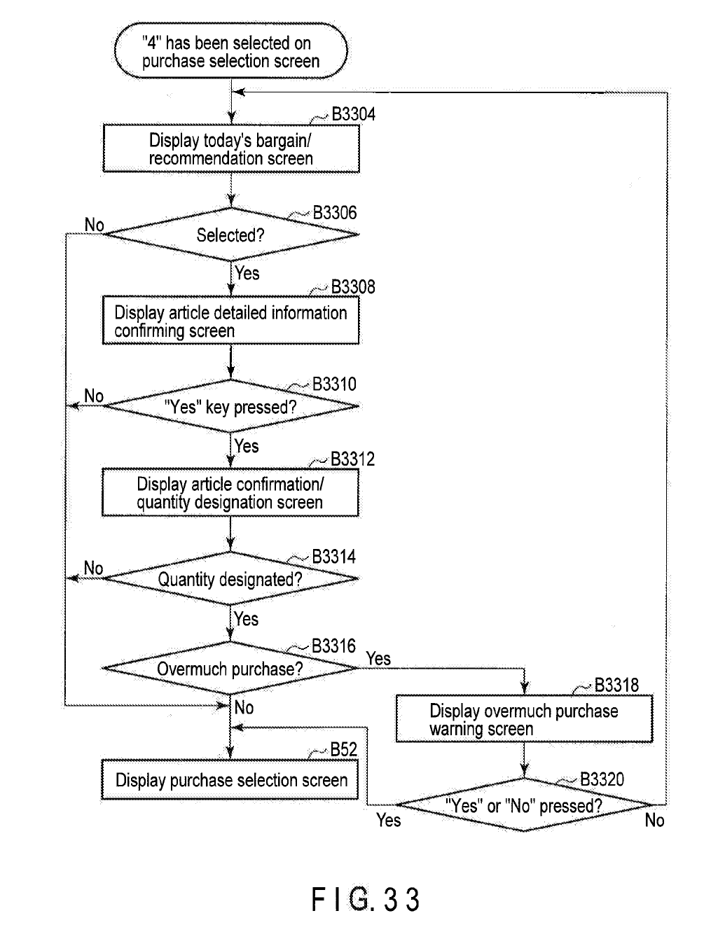

FIG. 33 is a flowchart of an example of the process performed after “4: Bargain/recommendation” is selected on the purchase selection screen of FIG. 8.

In block B3304, a today's bargain/recommendation screen as shown in FIG. 34 is displayed. The today's bargain/recommendation screen shows a list of featured articles (with their pictures).

If it is determined in block B3306 that none of the articles has been selected, the program returns to block B52 (shown in FIG. 4) where the purchase selection screen (shown in FIG. 8A) is displayed.

In contrast, if it is determined in block B3306 that one of the articles has been selected, the program proceeds to block B3308 where such an article detailed information confirming screen as shown in FIG. 15 is displayed, as in block B928.

If it is determined in block B3310 that the No key has been pressed, the program returns to block B52 (shown in FIG. 4) where the purchase selection screen (shown in FIG. 8A) is displayed. If it is determined in block B3310 that the “Yes” key has been pressed, the program proceeds to block B3312 where such an article confirmation/quantity designation screen as shown in FIG. 16 is displayed, as in block B932. If there is no designation of article quantity, the program returns to block B52 (shown in FIG. 4) where the purchase selection screen (shown in FIG. 8A) is displayed.

If it is determined in block B3314 that one of the “1” to “9” keys has been pressed to designate article quantity, it is then determined in block B3316 whether overmuch purchase has been made, as in block B936. If it is determined that no overmuch purchase is made, the program returns to block B52 (shown in FIG. 4) where the purchase selection screen (shown in FIG. 8A) is displayed. In contrast, if it is determined that overmuch purchase is made, the program proceeds to block B3318, where an “overmuch purchase warning screen” as shown in FIG. 17 is displayed, as in block B938.

If it is determined in block B3320 that the No key has been pressed, the program returns to block B3304 where the Bargain/recommendation screen is displayed. If it is determined in block B3320 that the “Yes” key has been pressed, the program returns to block B52 (shown in FIG. 4) where the purchase selection screen (shown in FIG. 8A) is displayed.

As described above, when “4: Bargain/recommendation” is selected as the way of shopping, bargain articles or recommended articles can be efficiently purchased.

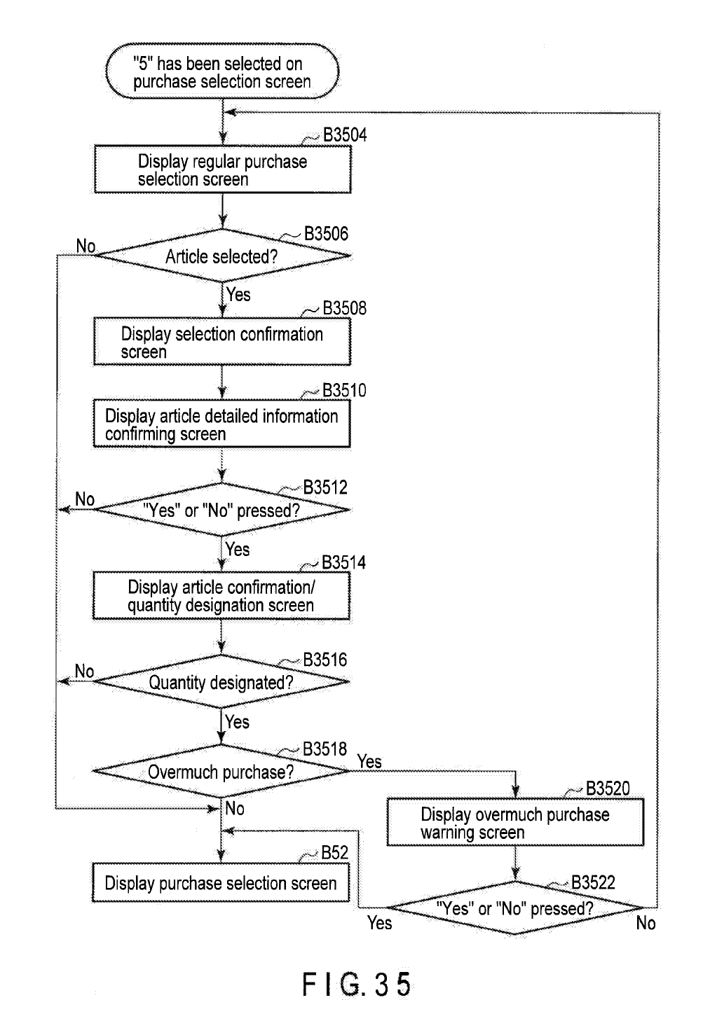

FIG. 35 is a flowchart of an example of the process performed after “5: Regular purchase” is selected on the purchase selection screen of FIG. 8.

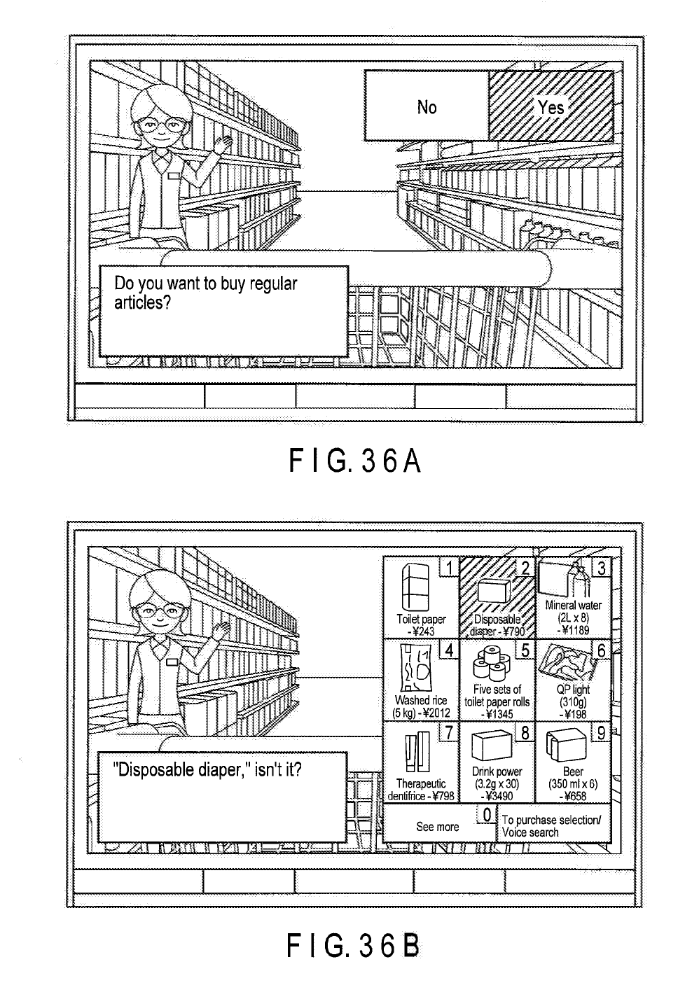

In block B3504, a regular purchase selection screen as shown in FIG. 36A is displayed. The regular purchase selection screen displays the indoor scenery of the store, and a cartoon character as a net shopping operator. This screen also displays key numbers with categories and prices, i.e., “1: Toilet paper—243 yen, 2: Disposable diaper—790 yen, 3: Mineral water (21×8)—1189 yen, 4: Washed rice (5 kg)—2012 yen, 5: Five sets of toilet paper rolls—1345 yen, 6: QP light (310 g)—198 yen, 7: Therapeutic dentifrice—798 yen, 8: Drink power (3.2 g×30)—3490 yen, 9: Beer (350 ml×6—658 yen, 0: See more, to purchase selection/voice search,” and a message “Do you want to buy regular articles?” Simultaneously with this display, the sound controller 54 generates a guidance voice message “Do you want to buy regular articles?” and outputs it through the loudspeaker 52.

If it is determined in block B3506 that none of the articles has been selected, the program returns to block B52 where the purchase selection screen shown in FIG. 8A is displayed.

If one of the articles has been selected in block B3506, a selection confirming screen as shown in FIG. 36B is displayed in block B3508. The selection confirming screen displays a message “Disposable diaper, isn't it?” instead of the message “Do you want to buy regular articles?” shown in FIG. 36A. At the same time, the sound controller 54 generates a guidance voice message “Disposable diaper, isn't it?” and outputs it through the loudspeaker 52.

In block B3510, an article detailed information confirming screen as shown in FIG. 15 is displayed, as in blocks B928 and B3308.

If it is determined in block B3512 that the No key has been pressed, the program returns to block B52 (shown in FIG. 4) where the purchase selection screen (shown in FIG. 8A) is displayed. If it is determined in block that the “Yes” key has been pressed, the program proceeds to block B3514 where an article confirmation/quantity designation screen as shown in FIG. 16 is displayed, as in blocks B932 and B3312. In this case, if no article quantity is designated, the program returns to block B52 (shown in FIG. 4) where the purchase selection screen (shown in FIG. 8A) is displayed.

If it is determined in block B3516 that one of the “1” to “9” keys has been pressed to designate article quantity, it is then determined in block B3318 whether overmuch purchase is made, as in blocks B936 and B3316. If it is determined that no overmuch purchase is made, the program returns to block B52 where the purchase selection screen (shown in FIG. 8A) is displayed. In contrast, if it is determined that overmuch purchase is made, the program proceeds to block B3520 where an “overmuch purchase warning screen” as shown in FIG. 17 is displayed, as in blocks B938 and B3518.

If it is determined in block B3322 that the No key has been pressed, the program returns to block B3504 where the regular purchase selection screen is displayed. If it is determined that the “Yes” key has been pressed, the program returns to block B52 where the purchase selection screen (shown in FIG. 8A) is displayed.

Thus, when “5: Regular purchase” is selected as the way of shopping, regularly purchased daily commodities, for example, can be efficiently purchased in a short time.

As described above, since the embodiment utilizes an existing television receiver, the user can feel more comfortable and familiar in operation than in the case of using a dedicated machine, such as a personal computer. Further, it is sufficient if the remote controller has a simple structure comprising numeral keys and several limited keys, and is therefore simple in operation. Also, since the electronic device, in which setting for connection to the Internet is already made, is distributed to each user, each user does not have to make setting for connection to the Internet. This enables even a person who is unfamiliar with operation of a personal computer to start online shopping easily. Moreover, by virtue of the GUI obtained by combining video, text and voice data, the user can feel as if they are shopping in actual stores. Thus, mechanical net (online) shopping can be converted into realistic shopping. Furthermore, since on the screen, guidance messages, and remote control keys with the operations that are performed when the keys have been pressed, are both displayed, it can be easily understood which key should be pressed to realize each operation. Thus, the user will not hover on operation.

Articles can be selected not only from a list, but also through voice input of, for example, the names of the articles. If a plurality of voice recognition results are obtained, limited search is performed utilizing associated article classification information beforehand obtained from a database, thereby efficiently obtaining a recognition result close to the input voice.

For identity verification for enhancing security, a user ID and a password are necessary. Since, however, the ID of the SIM card contained in the electronic device 12 is used as the user ID, setting and input of the user ID are not necessary. As a result, identity verification can be realized by such a simple operation as input of the password only.

Further, the subscriber information includes a purchase history. If the user does not buy a certain article even after a predicted regular purchase date determined at the time of, for example, a purchase settlement, based on a past purchase history and article attributes, a regular purchase forget warning screen is displayed to cause the user to pay attention to it. Further, if it is determined at the time of, for example, a purchase settlement, that the sum of the money amount (accumulated total) already spent this month and the money amount intended to be spent for further articles this month exceeds a monthly budget set by the user (online shopper), a monthly overbudget warning screen is displayed to cause the user to pay attention to the overbudget state.

In addition, at the time of article selection, if it is determined, by comparing the history (article names and quantities) of one-day purchased articles with selected articles (article names and quantities), that duplicate purchase has occurred, a one-day duplicate-purchase warning screen is displayed. Similarly, at the time of article selection, if it is determined, by comparing the history (article names and quantities) of multi-day purchased articles with selected articles (article names and quantities), that duplicate purchase has occurred, a multi-day duplicate-purchase warning screen is displayed. As a result, duplicate purchase can be avoided.

Moreover, if it is determined, when, for example, the quantity of articles is designated, that a large number of same or similar articles have been purchased, an excessive purchase warning screen is displayed.

Thus displaying warning screens for preventing human errors on a display screen enables even users unfamiliar with online shopping to perform shopping at ease. The human errors include, for example, forgetting of purchase of articles regularly purchased so far, exceeding of purchase budget, purchase of the same articles on the same day, purchase of the same articles within last several days, and purchase of a large number of same or similar articles.

The present invention is not limited to the above-described embodiments, but may be modified in various ways without departing from the scope. Various inventions can be realized by appropriately combining the structural elements disclosed in the embodiments. For instance, some of the disclosed structural elements may be deleted. Some structural elements of different embodiments may be combined appropriately.

The sound controller 54 may generate a BGM or effective sounds, as well as guidance voice messages. The cartoon character may be a still image or a moving image. A character corresponding to the user may be displayed. In this case, a plurality of voice messages may be generated. Alternatively, only an article may be zoomed and displayed when selected. Yet alternatively, an article may be displayed in a three-dimensionally. The embodiment may be realized by installing software in a tablet terminal. Instead of or in addition to identify verification using a password, identify verification using a finger print may be performed before power on of the device.

Since the processing of the embodiment can be executed by a computer program, the same advantage as the embodiment can be easily realized simply by installing the computer program in the computer through a computer-readable recording medium storing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a hardware processor configured to display, on a screen of a television receiver, an article selection menu displaying article names and key numbers, the key numbers being associated with the article names;
a receiver configured to receive key number data from a wireless remote controller comprising numeric keys; and
a transmitter configured to transmit a purchase instruction to a server via a network, the instruction comprising the article names based on the key number data received.

2. A method comprising:
displaying, on a screen of a television receiver, an article selection menu displaying article names and key numbers, the key numbers being associated with the article names;
receiving key number data from a wireless remote controller comprising numeric keys; and
transmitting a purchase instruction to a server via a network, the instruction comprising the article names based on the key number data received.

3. A non-transitory computer-readable storage medium having stored thereon a computer program which is executable by a computer, the computer program comprising instructions capable of causing the computer to execute functions of:
displaying, on a screen of a television receiver, an article selection menu displaying article names and key numbers, the key numbers being associated with the article names;
receiving key number data from a wireless remote controller comprising numeric keys; and
transmitting a purchase instruction to a server via a network, the instruction comprising the article names based on the key number data received.

4. The electronic device of claim 1, wherein the selection menu further displays a text message suggesting pressing of the numeric key of the remote controller based on an article to be purchased.

5. The electronic device of claim 4, wherein the transmitter is further configured to transmit the purchase instruction to a base station via a wireless telephone line, the base station being connected to the server via the network.

6. The electronic device of claim 5, wherein
the remote controller comprises a microphone, and
the electronic device further comprises a voice recognition processor configured to perform voice recognition using a database of purchasable articles and display one of the purchasable articles which corresponds to or is most similar to the recognition result.

7. The electronic device of claim 6, wherein the hardware processor is further configured to display on the screen of the television receiver, a shopping mode selection menu displaying shopping mode names and the key numbers, the key numbers being associated with the shopping mode names.

8. The electronic device of claim 7, wherein the shopping menu further displays a text message suggesting pressing of the numeric key of the remote controller based on the shopping mode to be selected.

9. The method of claim 2, wherein the selection menu further displays a text message suggesting pressing of the numeric key of the remote controller based on an article to be purchased.

10. The method of claim 9, further comprising transmitting the purchase instruction to a base station via a wireless telephone line, the base station being connected to the server via the network.

11. The method of claim 10, wherein
the remote controller comprises a microphone, and
the method further comprises performing voice recognition using a database of purchasable articles and displaying one of the purchasable articles which corresponds to or is most similar to the recognition result.

12. The method of claim 11, further displaying on the screen of the television receiver, a shopping mode selection menu displaying shopping mode names and the key numbers, the key numbers being associated with the shopping mode names.

13. The method of claim 12, wherein the shopping menu further displays a text message suggesting pressing of the numeric key of the remote controller based on the shopping mode to be selected.

14. The storage medium of claim 3, wherein the selection menu further displays a text message suggesting pressing of the numeric key of the remote controller based on an article to be purchased.

15. The storage medium of claim 14, further comprising transmitting the purchase instruction to a base station via a wireless telephone line, the base station being connected to the server via the network.

16. The storage medium of claim 15, wherein
the remote controller comprises a microphone, and
the computer program further comprises instructions capable of causing the computer to execute functions of performing voice recognition using a database of purchasable articles and displaying one of the purchasable articles which corresponds to or is most similar to the recognition result.

17. The storage medium of claim 16, wherein the computer program further comprises instructions capable of causing the computer to execute functions of displaying on the screen of the television receiver, a shopping mode selection menu comprising key numbers with shopping modes to be performed when corresponding numeric keys of the remote controller are pressed.

18. The storage medium of claim 17, wherein the shopping menu further displays a text message suggesting pressing of the numeric key of the remote controller based on the shopping mode to be selected.
